(19) United States
(12) Patent Application Publication
(10) Pub. No.: US 2009/0177664 A9
(43) Pub. Date: Jul. 9, 2009

(54) System and Method for Regulatory Rules Repository Generation and Maintenance

(76) Inventors: Lynette I. Hotchkiss, Lake Forest, CA (US); Timothy T. Green, (US); Angela Cheek, (US)

Correspondence Address: TAYLOR RUSSELL & RUSSELL, P.C., 4807 SPICEWOOD SPRINGS ROAD, BUILDING TWO SUITE 250, AUSTIN, TX, 78759, US

(21) Appl. No.: 10/710,866

(22) Filed: Aug. 9, 2004

Related U.S. Application Data
(63) Continuation-in-part of application No. 10/249,784, filed on May 7, 2003.

(51) Int. Cl. G06F 17/30

(52) U.S. Cl. 707/100

(57) ABSTRACT

A system and method for deriving compliance requirements from statutes, regulations, case law, official interpretations, attorney general opinions, determination and other interpretive letters, administrative agency regulations, and sources prescribing and interpreting compliance requirements for a jurisdiction, preparing compliance rules documentation that reflect these regulatory requirements, creating computer-encoded compliance rules from the compliance rules documentation, and storing these computer-encoded compliance rules in a compliance rules repository within a regulatory compliance computer system. The jurisdiction may be Federal, state or local authority. The regulatory compliance computer system makes use of the computer-encoded compliance rules by extracting compliance review data from a institution's data system and archiving the institution's data file in a compliance review file database, comparing the compliance review file against the applicable computer-encoded compliance rules in the rules repository, and preparing a regulatory compliance results file that captures noncompliant data in the institution's data system.

### BACKGROUND OF INVENTION

The present invention relates generally to systems and methods for ensuring that compliance review files provided by financial institutions comply with the most currently applicable Federal, state and local laws and regulations. This may be accomplished by applying a set of computer-encoded compliance rules to the information obtained from a financial institution concerning financial transactions. More particularly, the invention is a system and method for deriving compliance requirements from statutes, regulations, case law, official interpretations, attorney general opinions, determination and other interpretive letters, administrative agency regulations, and any other sources prescribing or interpreting compliance requirements for a jurisdiction. The invention also includes prescribing or interpreting compliance requirements, preparing compliance rules documentation, creating computer-encoded compliance rules from the compliance rules documentation for use in a regulatory compliance computer system, and storing these computer-encoded compliance rules in a compliance rules repository within the regulatory compliance computer system. The regulatory compliance computer system makes use of the computer-encoded compliance rules by extracting compliance review data from a financial institution's data repository system and archiving the institution's compliance review data file into a compliance review file database, comparing the compliance review data file against the applicable computer-encoded compliance rules in the compliance rules repository, and preparing a regulatory compliance results file that captures noncompliant data in the compliance review data file.

Regulatory compliance requirements are prevalent in many industry sectors. Most of these regulations have been promulgated for protection of consumers. To protect consumers involved in these transactions, the Federal government as well as state and local governments have enacted laws and regulations that impose requirements on institutions and personnel involved in these businesses. These laws and regulations establish transactional standards and disclosure requirements that are enforced by Federal, state, and local agencies. As new laws, regulations, licenses, and rules are added over time, business transactions have become more varied, complex and prone to error, resulting in an increase in exposure to non-compliance liabilities for the businesses that are engaged in these regulated activities. For example, with the growing complexity of the financial services industry, consumers are frequently subjected to compliance errors, overcharges, and careless practices in processing loans.

Federal, state, and local regulators are conducting increasingly aggressive policing campaigns to ensure compliance by the financial services industry. These efforts have significantly increased the costs for non-compliance in terms of monetary penalties and legal expenses, as well as in terms of tarnished reputations to the financial institutions. Because of the substantial growth in Internet and multi-state activities, the potential for serious compliance violations is likely to increase along with a corresponding increase in compliance scrutiny and enforcement activities by Federal, state, and local regulatory agencies. The financial services industry faces the prospect of significant losses if they are forced to refund fees and charges, void noncompliant transactions, and pay civil and criminal penalties. To counter these potential losses, the industry will incur increased expenses associated with compliance audits and compliance policies, procedures and reporting.

In order to overcome these problems and to satisfy regulatory compliance requirements, institutions offering financial services to consumers have attempted to audit transaction compliance on a manual basis. This approach results in a tedious, time-consuming and costly process that allows only a small statistical sample of transaction applications to be examined for compliance with requirements. The results of this process are also oftentimes inconsistent due to factors such as varying degrees of understanding, differences in interpretation of the laws and regulations and human processing errors. As competition increases, there is a strong need to reduce the cost of adherence to regulatory compliance standards as well as to reduce penalties for failure to meet compliance requirements. For example, some mortgage companies have attempted to employ risk management techniques, which have proved inadequate as a solution to compliance and related liability problems. While the home mortgage loan industry is probably more regulated than other industries, the compliance difficulties are also encountered in many other areas. Other applications where automated compliance assessment would reduce costs and speed transaction processing include automobile and other consumer loans, leasing transactions, as well as regulatory requirements for other industries, including but not limited to the healthcare and environmental-related industries.

In response to the increased regulatory burden, financial institutions are increasingly relying on automated computer-based methods for ensuring regulatory compliance of their transaction data files in their data repositories. One of the most critical aspects of these automated systems is the derivation of computer-encoded compliance rules from the regulatory requirements of statutes, regulations, case law, official interpretations, attorney general opinions, determination and other interpretive letters, administrative agency regulations, and any other sources prescribing or interpreting compliance requirements. These derived computer-encoded compliance rules must provide an accurate representation of the regulatory requirements and must be traceable back to relevant sections of the statutes, regulations, case law, official interpretations, attorney general opinions, determination and other interpretive letters, administrative agency regulations, and any other sources prescribing or interpreting compliance requirements. These computer-encoded compliance rules form the foundation upon which the accuracy, integrity and reputation of an associated regulatory compliance system depend.

### SUMMARY OF INVENTION

The present invention provides a system and method for deriving computer-encoded compliance rules for a regulatory compliance system that provide an accurate representation of the regulatory requirements and are traceable back to relevant compliance sources. The computer-encoded compliance rules provide compliance assurance for the consumer, the financial services industry, Federal, state, and local regulatory agencies, and the investment community. The computer-encoded compliance rules are used by a regulatory compliance system to verify that all compliance review data for every transaction adheres to the most current Federal, state, local and other requirements. For example, requirements for the mortgage lending industry include the following:
Truth-In-Lending Act (TIL) Requirements
Real Estate Settlement Procedures Act (RESPA)
Home Mortgage Disclosure Act (HMDA)
Office of Foreign Asset Control (OFAC)
Home Ownership and Equity Protection Act (HOEPA)
Originator and Lender Licensing Requirements
State Regulatory Laws Regulating Financial Transactions
State and Local High Cost Calculations Requirements
Predatory Lending Rules and Regulations

Using the mortgage lending industry as an example, the computer-encoded compliance rules are used by a regulatory compliance system to ensure that the data is free of calculation errors, interest/usury rate violations, finance charge restrictions, and prohibited practices. These include, but are not limited to, high-cost loan restrictions, loan term and amortization restrictions, restricted/prohibited charges and fees, late charge limitations, and prepayment penalty limitations that may lead to violations of applicable Federal, state and local requirements. As a result of the computer-encoded compliance rules, any areas of noncompliance are identified as exceptions and presented to the processing agent by the regulatory compliance system for corrective action.

Regulatory compliance determination is accomplished by applying a set of computer-encoded compliance rules to the compliance review data for each financial transaction. To create new or revised computer-encoded compliance rules, outside legal counsel provides an in-house legal team with information concerning new or revised Federal, state and local laws related to the industry at issue, and an associated legal opinion. The in-house legal team compares the new or revised law with a compliance subjects checklist, and prepares a rule documentation report that forms a baseline for the preparation of the computer-encoded compliance rules. The rule documentation report is sent to outside legal counsel for review and approval to ensure consistency and compliance with a previous opinion and related law. The in-house legal team then performs a law-to-rule conversion of related laws and prepares specifications in the form of rule change requests, which are implemented by the in-house legal technologists. After the in-house legal technologist encodes and tests the revised or new rules, the in-house legal team reviews and validates the new or revised computer-encoded compliance rules, and releases the new or revised rules for installation and deployment in a compliance rules repository of a regulatory compliance computer system. The regulatory compliance system compares compliance review files with the computer-encoded rules stored in the compliance rules repository, and generates a results file that documents areas of compliance and noncompliance with the computer-encoded compliance rules. A regulatory compliance system that makes use of the present invention is disclosed in U.S. patent application Ser. No. 10/249784 entitled SYSTEM AND METHOD FOR AUTOMATED LOAN COMPLIANCE ASSESSMENT, filed on May 7, 2003, which is incorporated herein by reference.

Outside legal counsel consists of many of the leading experts in the Federal, state, and local financial services compliance industry. They provide the in-house legal team with existing laws in all Federal, state and applicable local jurisdictions related to the financial services industry. In addition, these experts continuously provide the in-house legal team with updates on new laws, changes or amendments to existing laws, rules, regulations and administrative codes. Outside legal counsel's responsibilities include monitoring changes in legislation, regulations, case law, official interpretations, attorney general opinions, determination and other interpretive letters, administrative agency regulations, and any other sources prescribing or interpreting compliance requirements and providing interpretations and explanations concerning these changes.

The in-house legal team is a part of an organization responsible for operating and maintaining a regulatory compliance system, and is headed by a senior legal counsel who is an expert in financial services compliance with extensive experience in providing compliance solutions through software solutions. The in-house legal team is trained not only in financial services compliance but also in the application of compliance requirements to software solutions. Responsibilities of the in-house legal team include the following:
Providing legal interpretation in conjunction with outside legal counsel
Determining whether new rules need to be implemented
Determining whether existing rules need to be revised
Creating and maintaining rule documentation
Developing plain English interpretation and program results for program enhancement
Obtaining outside legal counsel approval for legal interpretations and program results
Developing change requests in a change tracking system for triggering the development process
Monitoring and validating change requests as they make their way through the change tracking system
Working with the quality assurance team through the testing process

The in-house legal technologists are also a part of an organization responsible for operating and maintaining a regulatory compliance system, and have responsibility for translating the legal regulatory requirements into quantifiable logic, testing the logic, and working with the quality assurance team through the testing process.

An embodiment of the present invention is a method for generation and maintenance of a regulatory compliance rules repository for regulatory compliance assessment, comprising the steps of comparing a law imposing requirements for regulated transactions with a compliance subjects checklist for determining whether a change is required in the regulatory compliance rules repository of a regulatory compliance assessment system, the compliance subjects checklist listing subjects addressed by the regulatory compliance assessment system, preparing a rule documentation report if a change is required in the regulatory compliance rules repository, the rule documentation report being derived from the law and describing intended results in the regulatory compliance assessment system due to the change and an explanation of the change, preparing at least one rule change request upon approval of the rule documentation report, the rule change request being derived from the rule documentation report and including rule logic, expected rule results in the regulatory compliance assessment system, relevant law, and legal description, creating at least one new computer-encoded compliance rule from the at least one rule change request, the new computer-encoded compliance rule being tested, validated, and approved prior to release to the regulatory compliance rules repository, and assessing regulatory compliance of a compliance review file using a compliance engine to assess the compliance review file using the new computer-encoded compliance rule in the regulatory compliance rules repository to produce a regulatory compliance assessment result file, the regulatory compliance results file indicating subject areas in the compliance review file in compliance and non-compliance with the law. The step of comparing a law may be selected from the group consisting of comparing an existing law, comparing a new law, and comparing a revised law. The step of comparing a law may consist of a step selected from the group consisting of comparing a statute, comparing a regulation, comparing a case law, comparing an official interpretation, comparing an attorney general opinion, comparing a determination and other interpretive letter, comparing an administration agency regulatory requirements, and comparing a source prescribing and interpreting compliance requirements. The step of comparing a law may further comprise the step of comparing a law from a jurisdiction selected from the group consisting of a Federal jurisdiction, a state jurisdiction and a local jurisdiction. The method may further comprise the step of reviewing the law, generating a legal update and opinion document, and forwarding the legal update and opinion document by an outside legal counsel to an in-house legal team. The method may further comprise the step of reviewing the legal update and opinion document by the in-house legal team in consultation with the outside legal counsel. The step of comparing may further comprise comparing by an in-house legal team. The step of preparing a rule documentation report may comprise preparing a rule documentation report by an in-house legal team with consultation, review and approval by an outside legal counsel of the rule documentation report, and transmitting the approved rule documentation report back to the in-house legal team. The step of preparing at least one change request may comprise preparing at least one change request by an in-house legal team. The method may further comprise the step of entering the change request into a change tracking system and approving the change request by an in-house legal team. The method may further comprise the step of reviewing the change request by an in-house legal technologist in consultation with an in-house legal team. The step of creating at least one computer-encoded compliance rule may further comprise creating at least one computer-encoded compliance rule by an in-house legal technologist. The method may further comprise the step of testing the at least one new computer-encoded compliance rule by a quality assurance team. The step of creating at least one computer-encoded compliance rule may further comprise the new computer-encoded compliance rule being approved by the in-house legal team prior to release to the regulatory compliance rules repository.

Another embodiment of the present invention is a system for generation and maintenance of a regulatory compliance rules repository for regulatory compliance assessment, comprising means for comparing a law with a compliance subjects checklist for determining whether a change is required in the regulatory compliance rules repository of a regulatory compliance assessment system, the compliance subjects checklist listing subjects addressed by the regulatory compliance assessment system, means for preparing a rule documentation report if a change is required in the regulatory compliance rules repository, the rule documentation report being derived from the law and describing intended results in the regulatory compliance assessment system due to the change and an explanation of the change, means for preparing at least one change request upon approval of the rule documentation report, the rule change request being derived from the rule documentation report and including rule logic, expected rule results in the regulatory compliance assessment system, relevant law, and legal description, means for creating at least one new computer-encoded compliance rule from the at least one rule change request, the new computer-encoded compliance rule being tested, validated, and approved prior to release to the regulatory compliance rules repository, and a regulatory compliance assessment system for assessing regulatory compliance of a compliance review file using a compliance engine to process the compliance review file using the new computer-encoded compliance rule in the regulatory compliance rules repository to produce a regulatory compliance assessment result file, the regulatory compliance results file indicating subject areas in the compliance review file in compliance and non-compliance with the law. The law may be selected from the group consisting of an existing law, a new law, and a revised law. The law may be selected from the group consisting of a statute, regulation, case law, official interpretation, attorney general opinion, determination and other interpretive letter, administration agency regulatory requirements, and a source prescribing and interpreting compliance requirements. The law may be from a jurisdiction selected from the group consisting of a Federal jurisdiction, a state jurisdiction, and a local jurisdiction. The compliance subjects checklist may contain subjects including governing law, interest rate and finance charge, calculation of finance charges, payment and term limitations, loan amount limitations, late charges, prepayment, escrow and impound requirements, origination fees and licensing. The rule documentation report may be organized by jurisdiction, topic, subject and act. The act may be organized by program result, explanation of the law, citation, effective date, and version. The subject may be listed in the compliance subjects checklist. The change request may be organized according to identification, status, headline, customer priority, date required, description, failure response, program result, explanation of the law, and citation.

Yet another embodiment of the present invention is a system for generation and maintenance of a regulatory compliance rules repository for regulatory compliance assessment, comprising a law promulgated by a Federal, state or local jurisdiction imposing requirements for consumer financial transactions, a compliance subjects checklist including subjects addressed by a regulatory compliance assessment system for comparison with the law to identify if a change to the regulatory compliance rules repository is required, a rule documentation report derived from the law describing intended results of the identified change to the regulatory compliance assessment system, at least one change request derived from the rule documentation report describing rule logic, expected results in the regulatory compliance assessment system, relevant law and legal description, at least one new computer-encoded compliance rule for use by the regulatory compliance assessment system computer-encoded from information contained in the at least one rule change request and stored in the regulatory compliance rules repository, and the regulatory compliance assessment system comprising the regulatory compliance rules repository, at least one compliance review file, a compliance engine for assessing at least one compliance review file using the new computer-encoded compliance rule stored in the regulatory compliance rules repository, and storing compliance assessment results in a regulatory compliance results file, the regulatory compliance results file indicating subject areas in the compliance review file in compliance and non-compliance with the law. The law may be selected from the group consisting of a statute, regulation, case law, official interpretation, attorney general opinion, determination and other interpretive letter, administration agency regulatory requirements, and a sources prescribing and interpreting compliance requirements. The compliance subjects checklist may contain subjects including governing law, interest rate and finance charge, calculation of finance charges, payment and term limitations, loan amount limitations, late charges, prepayment, escrow and impound requirements, origination fees and licensing. The rule documentation report may be organized by jurisdiction, topic, subject and act. The act may be organized by program result, explanation of the law, citation, and effective date. The subject may be listed in the compliance subjects checklist. The change request may be organized according to identification, status, headline, customer priority, date required, description, failure response, program result, explanation of the law, and citation.

Another embodiment of the present invention is a method for generation and maintenance of a regulatory compliance rules repository for regulatory compliance assessment, comprising the steps of comparing a law imposing requirements for a regulated transaction with a compliance subjects checklist for determining whether a change is required in the regulatory compliance rules repository, creating at least one new computer-encoded compliance rule if a change is required in the regulatory compliance rules repository, assessing regulatory compliance of a compliance review file using new and existing computer-encoded compliance rules in the regulatory compliance rules repository; and producing a regulatory compliance assessment result file for indicating subject areas in the compliance review file in compliance and non-compliance with the new and existing computer-encoded compliance rules. The compliance subjects checklist may list subjects addressed for regulatory compliance assessment. The method may further comprise the step of preparing a rule documentation report if a change is required in the regulatory compliance rules repository. The rule documentation report may be derived from the law and describing intended results from the regulatory compliance assessment due to the required change in the regulatory compliance rules repository and an explanation of the required change. The method may further comprise the step of preparing at least one rule change request upon approval of the rule documentation report. The rule change request may be derived from the rule documentation report and includes rule logic, expected rule results from the regulatory compliance assessment, relevant law, and legal description. The step of creating at least one new computer-encoded compliance rule may further comprise creating at least one new computer-encoded compliance rule from the at least one rule change request, the new computer-encoded compliance rule being tested, validated, and approved prior to release to the regulatory compliance rules repository. The step of comparing a law may be selected from the group consisting of comparing an existing law, comparing a new law, and comparing a revised law.

### BRIEF DESCRIPTION OF DRAWINGS

These and other features, aspects and advantages of the present invention will become better understood with regard to the following description, appended claims, and accompanying drawings wherein:

FIG. 1 shows a high-level flow diagram of a regulatory compliance rules generation and maintenance process;

FIG. 2 shows a flow diagram of regulatory compliance rules generation depicting the steps required to prepare a rule change request;

FIG. 3 shows a flow diagram of regulatory compliance rules implementation for storage of computer-encoded rules in a compliance rules repository;

FIG. 4 shows a compliance subjects checklist;

FIG. 5 shows section 23-53-104 from Arkansas Code Title 23, Chapter 53, Arkansas Home Loan Protection Act;

FIG. 6 shows section 4-57-101 from Arkansas Code Title 4, Chapter 57, Arkansas Interest and Usury Provisions;

FIG. 7 shows selected sections from an Arkansas compliance rule documentation report;

FIG. 8 shows a summary of rule change request documents in a change tracking system;

FIG. 9 shows a rule change request in a change tracking system addressing balloon payments under the Arkansas Home Loan Protection Act, Arkansas Code Title 23, Chapter 53, section 104(f)(1);

FIG. 10 shows a rule change request in a change tracking system addressing negative amortization under the Arkansas Home Loan Protection Act, Arkansas Code Title 23, Chapter 53, section 104(g);

FIG. 11 shows a rule change request in a change tracking system addressing negative amortization under the Arkansas Interest and Usury Provisions, Arkansas Code Title 4, Chapter 57, section 101(c)(2);

FIG. 12 shows a screenshot from a regulatory compliance assessment system depicting rules derived from the Arkansas Interest and Usury Provisions and the Arkansas Home Loan Protection Act;

FIG. 13 shows an example of a screenshot from a regulatory compliance assessment system depicting elements of a rule for flagging noncompliance of a compliance review file providing a balloon payment requirement under the Arkansas Home Loan Protection Act;

FIG. 14 shows an example of a screenshot from a regulatory compliance assessment system depicting elements of a rule for flagging noncompliance of a compliance review file providing a negative amortization requirement under the Arkansas Home Loan Protection Act;

FIG. 15 shows an example of a screenshot from a regulatory compliance assessment system depicting elements of a rule for flagging noncompliance of a compliance review file providing a negative amortization requirement under the Arkansas Interest and Usury Provisions;

FIG. 16 shows an example of a screenshot of a partial compliance review file included within a compliance results file to be checked for compliance by the rules stored in a compliance rules repository;

FIG. 17 shows an example of a screenshot of a partial regulatory compliance results file depicting noncompliance with the rules shown in FIGS. 12-15 implemented with rule change requests shown in FIGS. 9-11; and

FIG. 18 shows the information flow between documents and corresponding example references according to the present invention.

### DETAILED DESCRIPTION

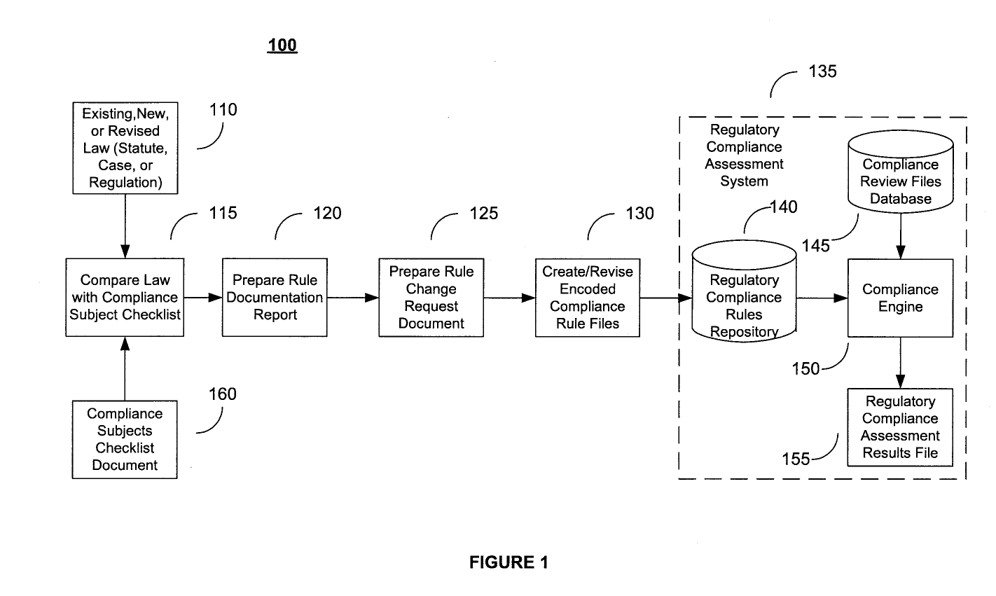

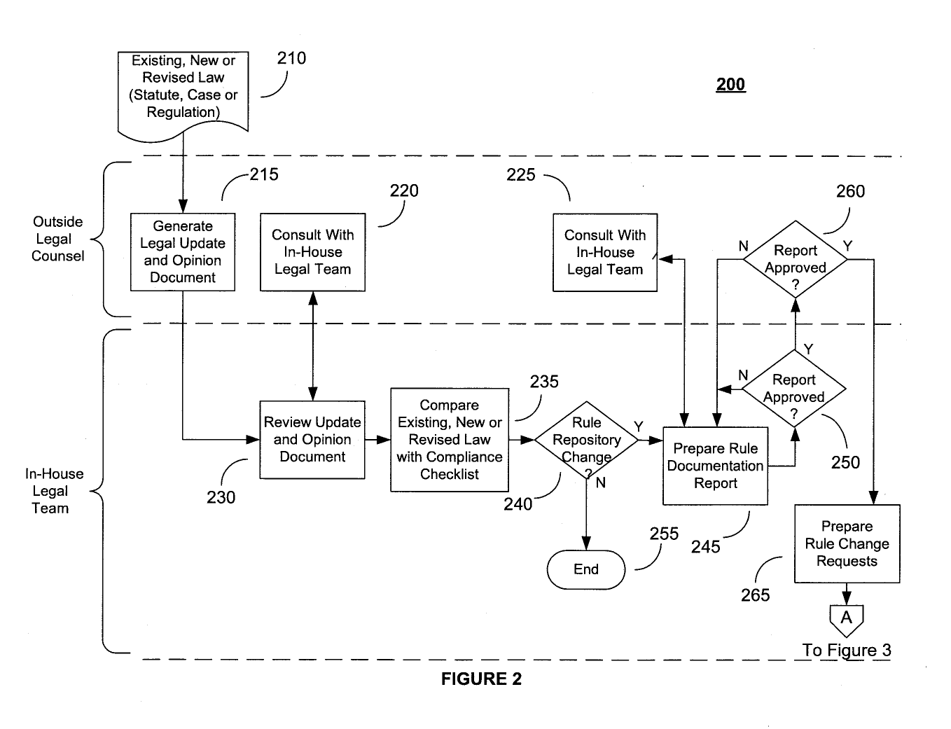

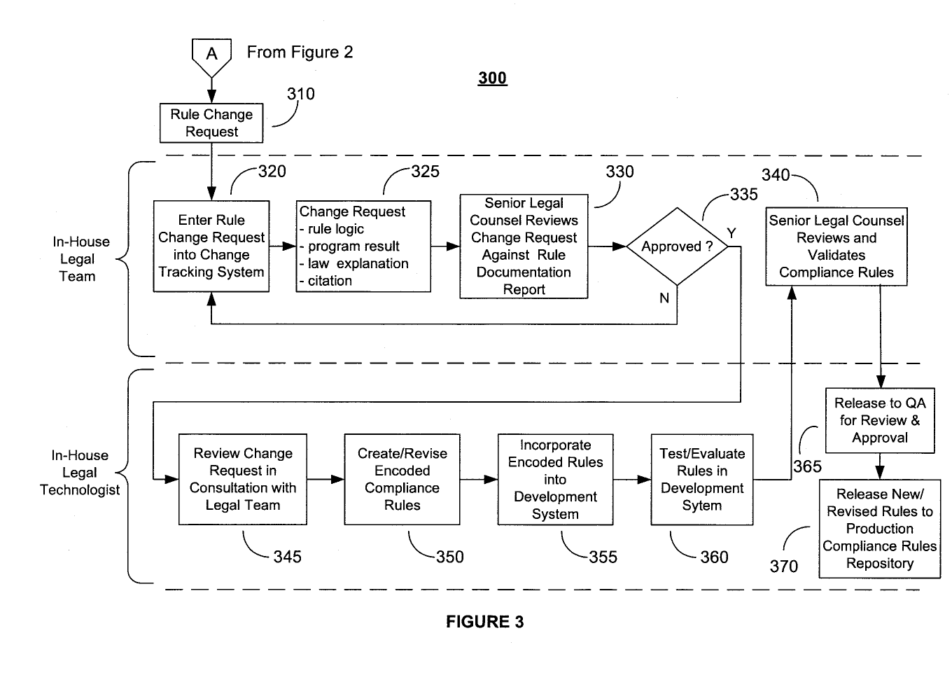

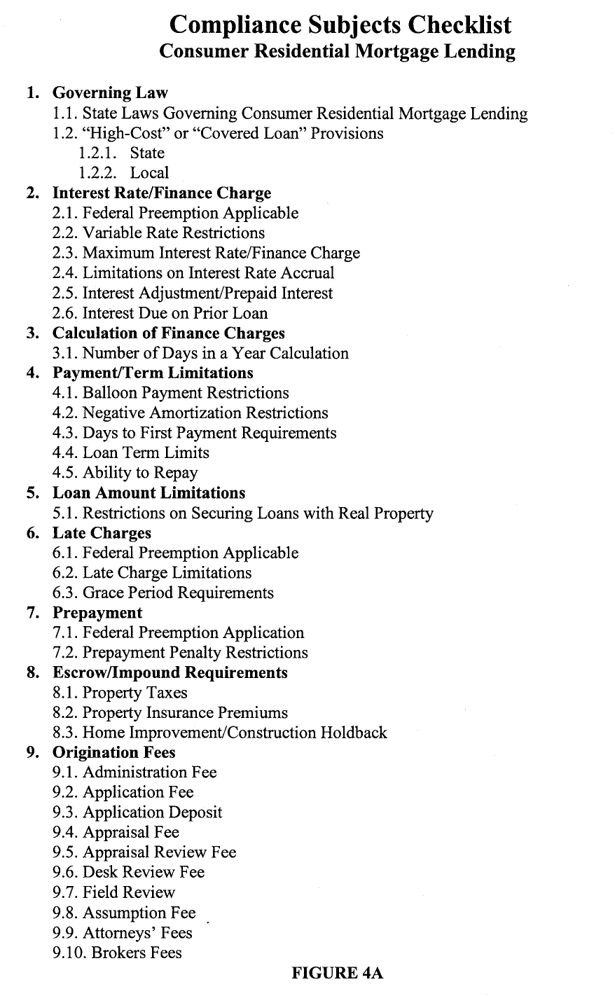

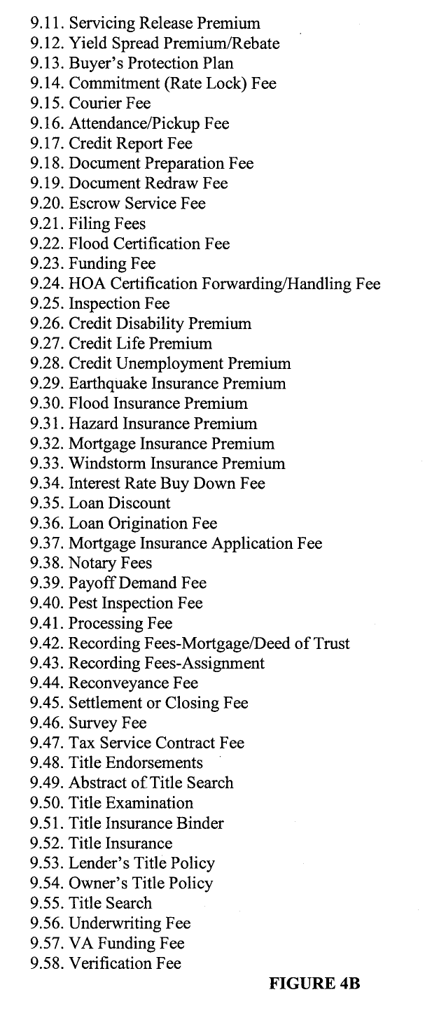

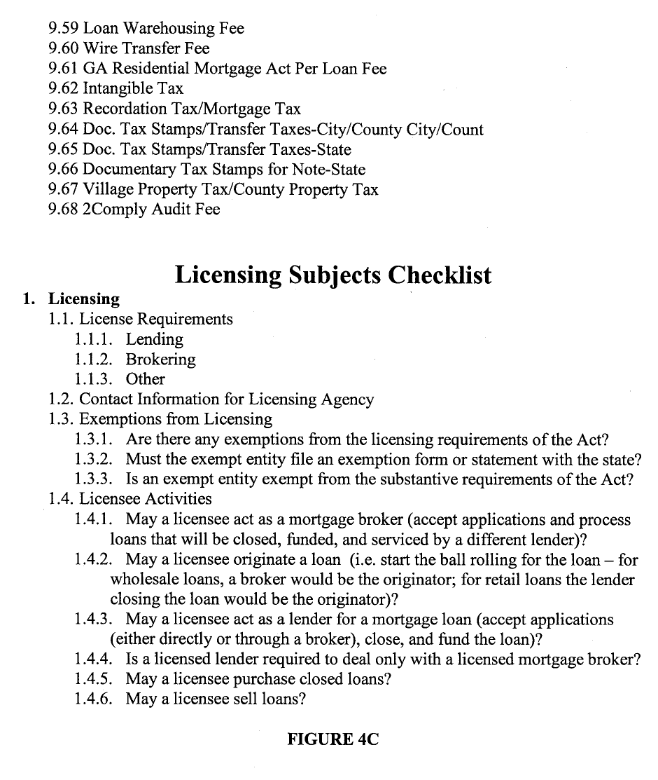

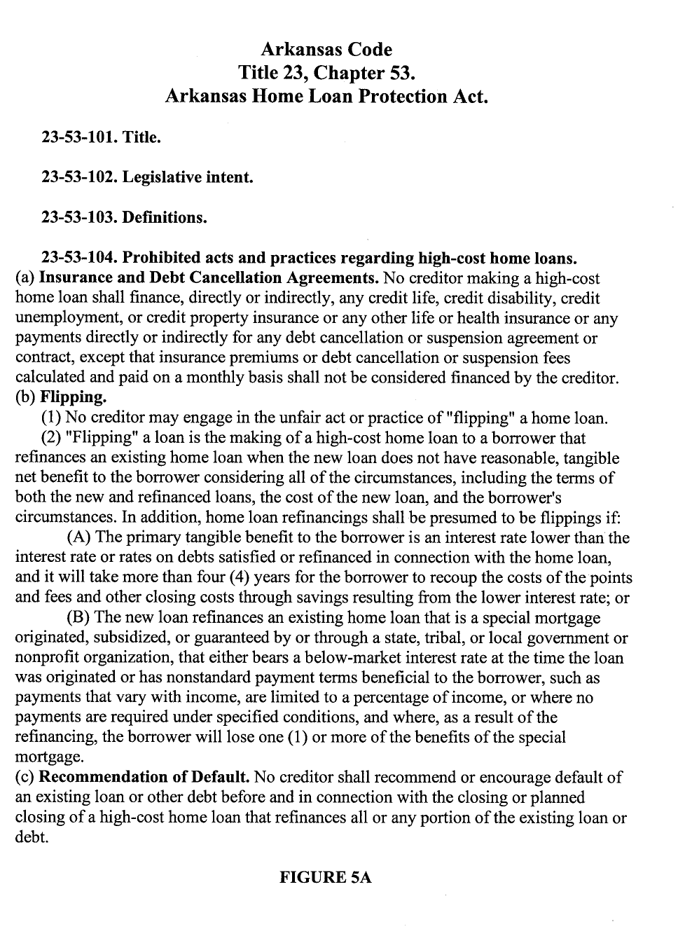

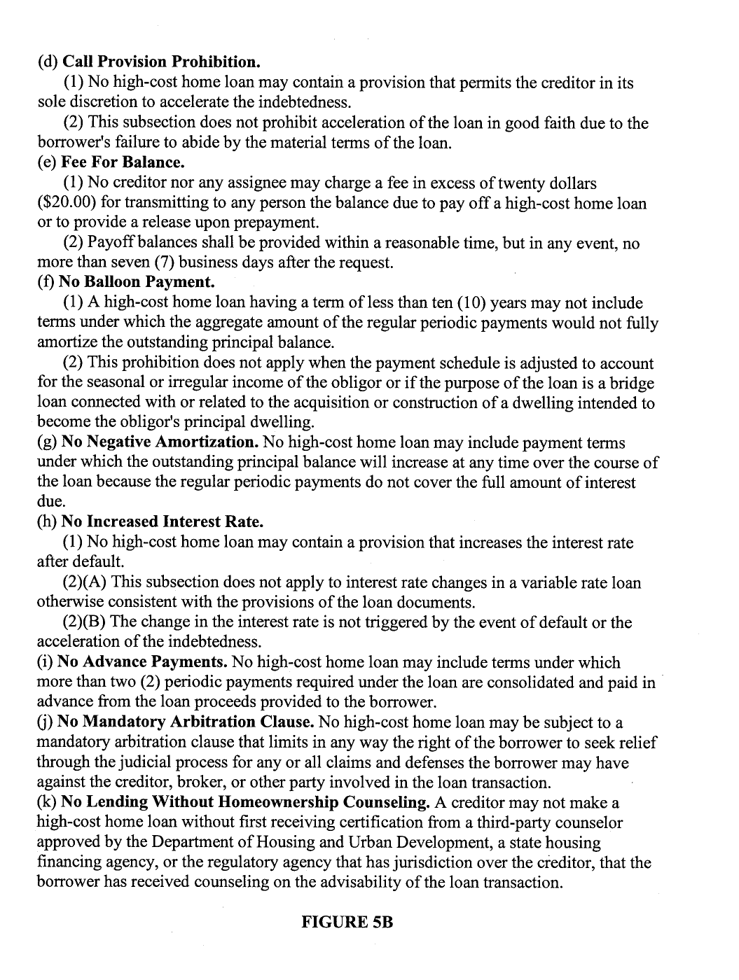

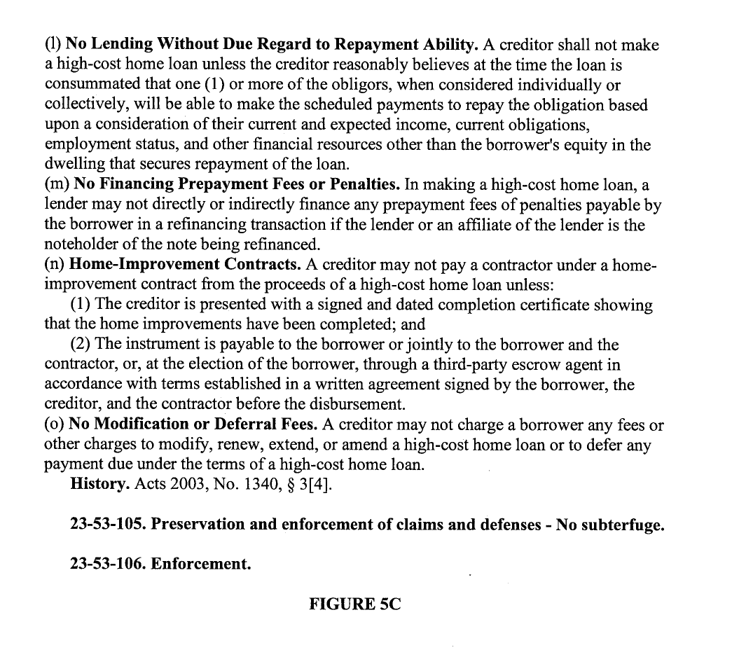

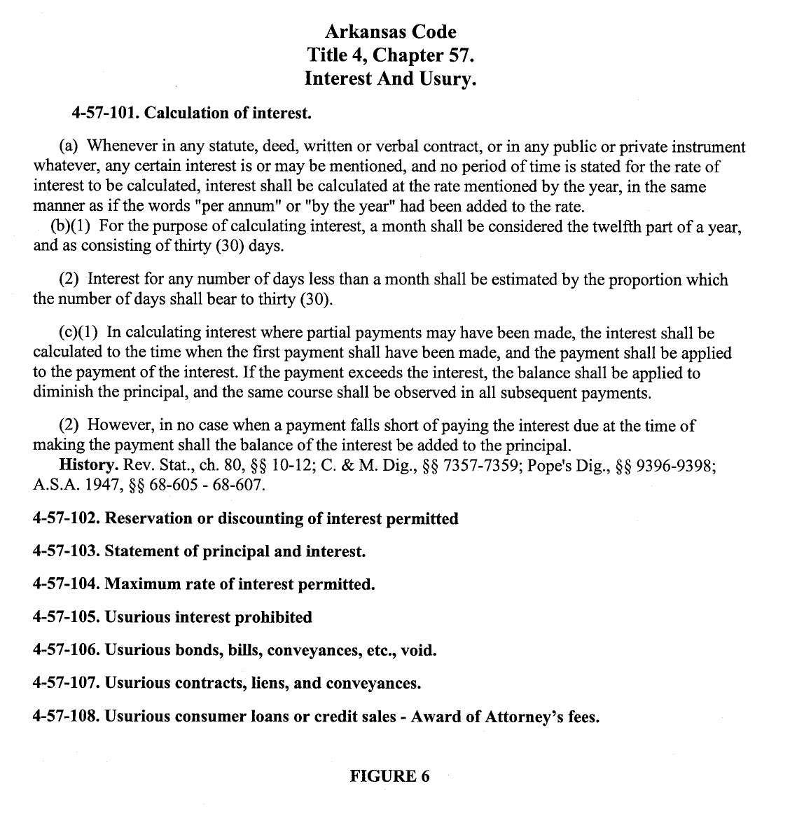

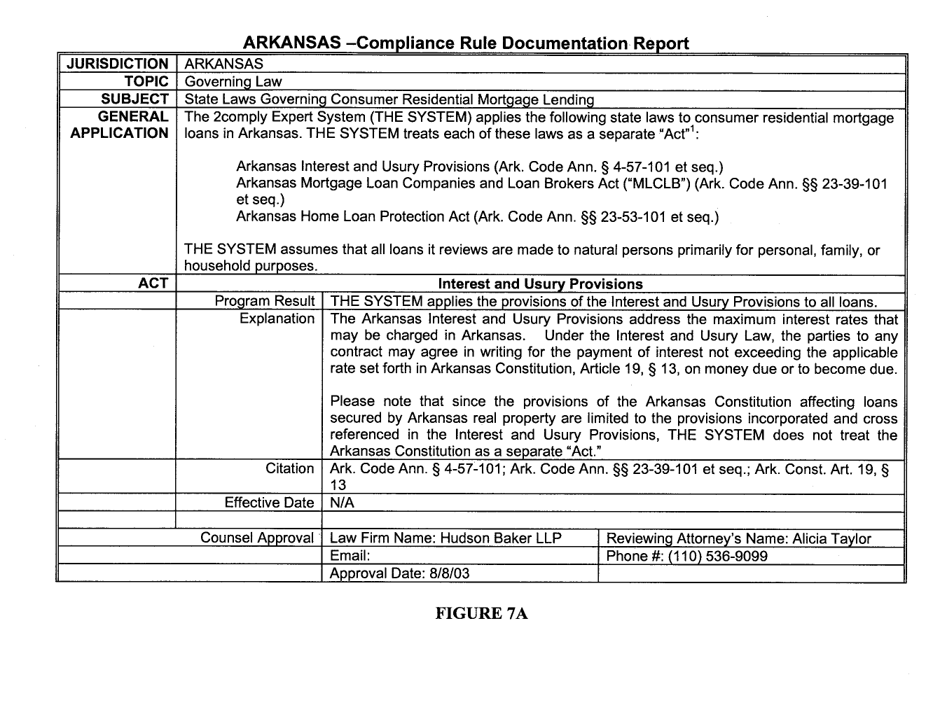

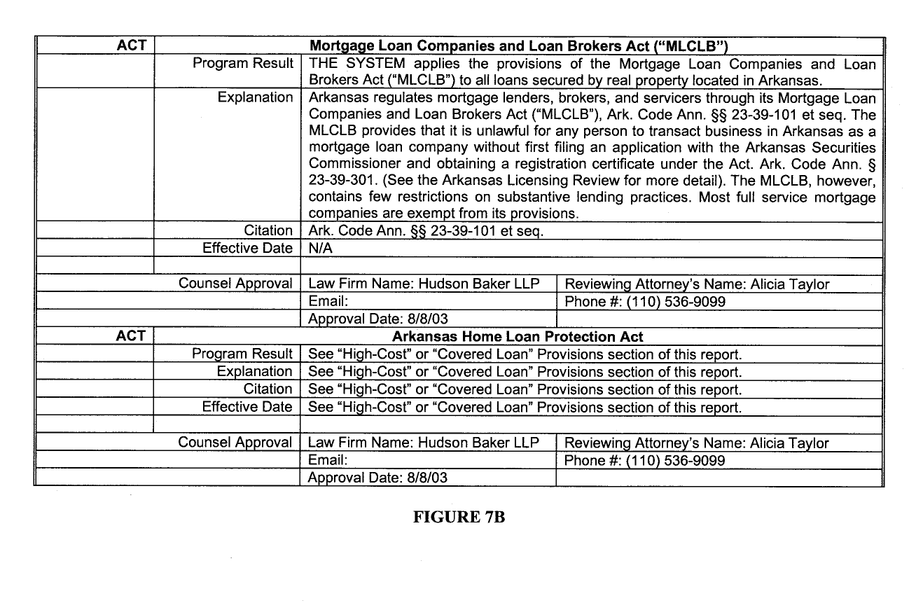

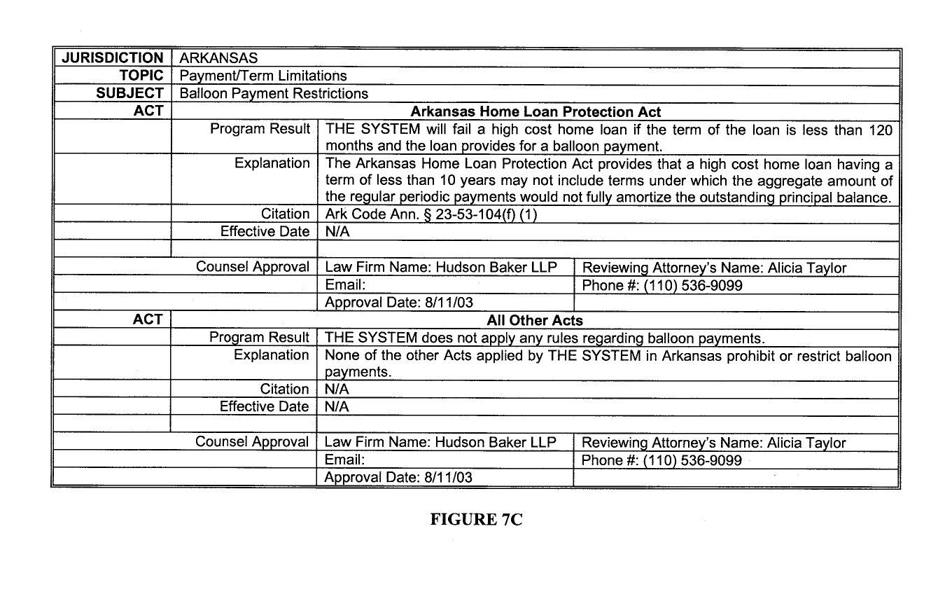

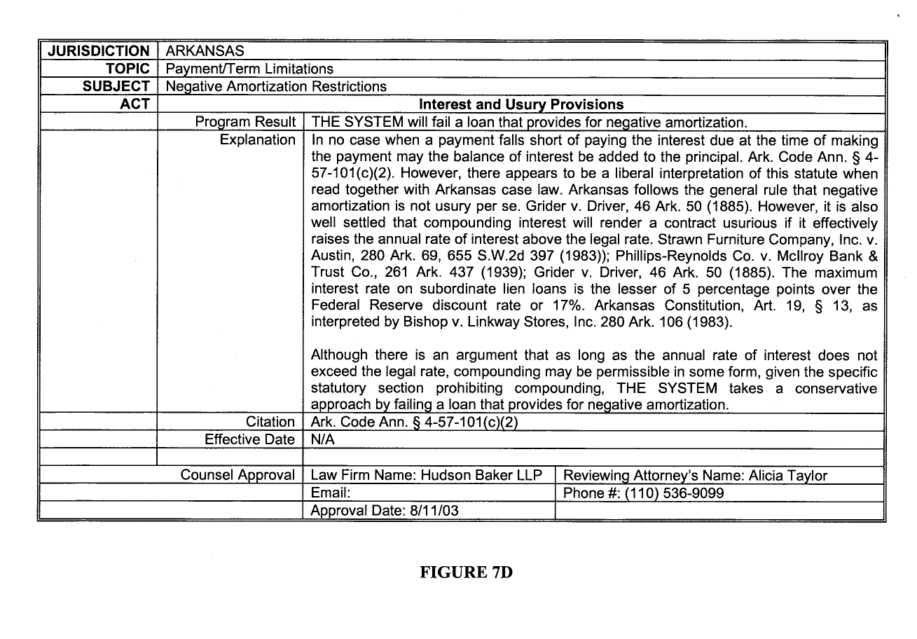

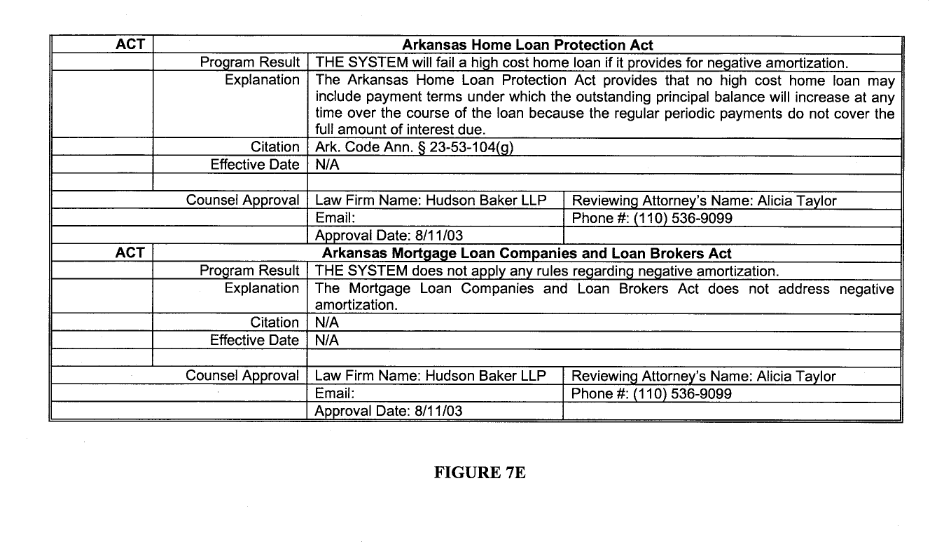

Turning now to FIG. 1, FIG. 1 shows a high-level flow diagram of a regulatory compliance rules generation and maintenance process 100. FIG. 2 and FIG. 3 depict a more detailed description of the process shown in FIG. 1. When a new or revised law is promulgated 110, it is compared with a compliance subjects checklist 115. The compliance subjects checklist 160 is organized by jurisdiction, topic, subject, and act as shown below in FIG. 4. Example sections of new or revised laws are shown below in FIG. 5 and FIG. 6. In the context of the present invention, a law is considered to be an existing law, a new law, a revised law or a new interpretation of an existing law derived from a compliance source that may be promulgated by Federal, state, or local authorities. Based on the comparison 115 of the law and checklist, a rule documentation report is prepared 120 that is derived from the requirements of the new or revised law 110. The rule documentation report 120, described below in FIG. 7, organizes the specific requirements of the new or revised law 110 by jurisdiction, topic, subject and act, and relates each specific requirement in the law to a defined compliance program explanation and compliance program result in a regulatory compliance assessment system 135. A rule change request document 125 is prepared based on the rule documentation report 120 defining requirements for a newly created or revised computer-encoded compliance rule, and ensures compliance in a regulatory compliance assessment system 135 with the requirements of the new or revised law 110. The rule documentation report 120 relates the specific requirements of a new or revised law 110 to the requirements of the result of an associated newly created or revised computer-encoded compliance rule 130 stored in a regulatory compliance system 135. When the new or revised computer-encoded compliance rule is created 130, it is stored in a compliance rule repository 140 of a regulatory compliance assessment system 135 for validation and production release in a regulatory compliance system 135. For determining regulatory compliance of a compliance review file contained in a compliance review files database 145 in a regulatory compliance system 135, a compliance engine 150 uses the computer-encoded rules in the compliance rules repository 140 to process the compliance review file in the compliance review file database 145 for determining compliance with regulatory requirements and stores the results in a regulatory compliance assessment results file 155.

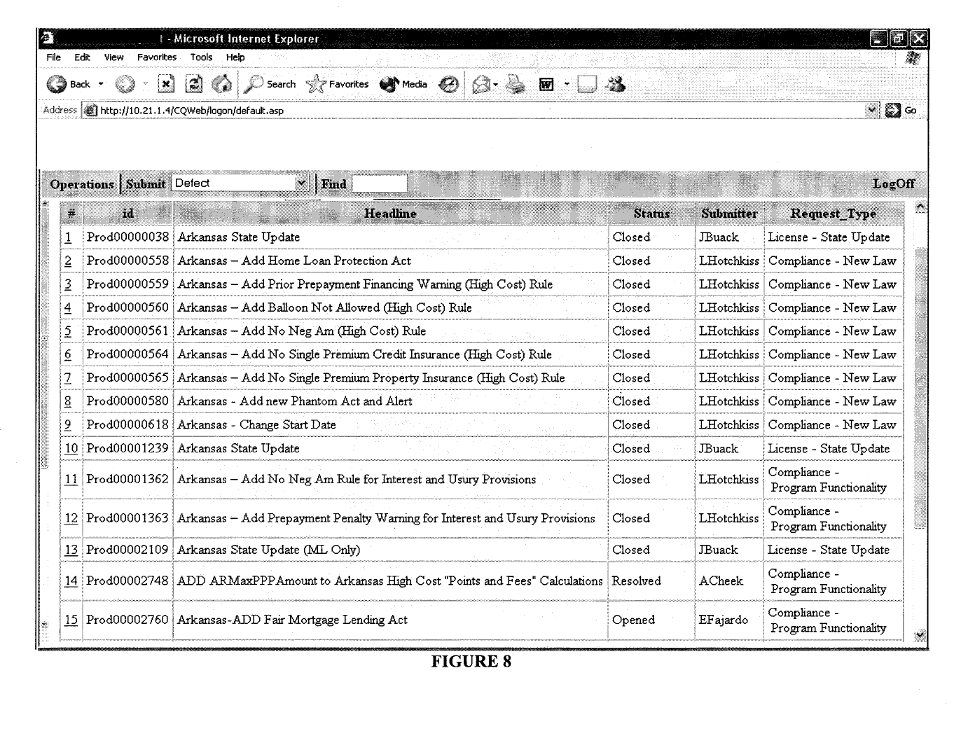

Turning to FIG. 2, FIG. 2 shows a flow diagram of regulatory compliance rules generation 200 depicting the steps required to prepare a rule change request. FIG. 2 depicts the step of generating compliance rules and FIG. 3 depicts the step of implementing the compliance rules. When a new, existing or revised law is promulgated 210, outside legal counsel generates a legal update and opinion document 215 concerning the law that is provided to an in-house legal team. The in-house legal team reviews the legal update and opinion document 230 and consults with outside legal counsel 220 regarding the law to determine whether a new or revised rule must be added to the system. When the in-house legal team reviews the legal update and opinion document 230, it compares the requirements of the new or revised law with a comprehensive compliance subjects checklist 235, in consultation with the outside legal counsel 255. If it is determined that a rules database change is not required 240, further consideration is terminated 255. If it is determined that a rules database change is required 240, the in-house legal team prepares a rule documentation report 245 in plain English, describing the intended program result in a compliance system and the legal basis for the rules enhancement. The rule documentation report 245, described below in FIG. 7, organizes the specific requirements of the new or revised law 210 by jurisdiction, topic, subject and act, and relates each specific requirement in the law to a defined compliance program explanation and compliance program result from an associated computer-encoded compliance rule. The rule documentation report 245 relates the specific requirements of a new or revised law 210 to the requirements of the result of an associated newly created or revised computer-encoded compliance rule. The in-house legal team consults with the outside legal counsel 225 in the preparation 245 of this report. When the in-house senior legal counsel approves the rule documentation report 250, it is transmitted to the designated outside legal counsel for the affected jurisdiction. Outside legal counsel reviews the rule documentation report 245 to ensure that the new or revised law 210 has been reflected in the rule documentation report 245 in a consistent manner and that the proposed program results will provide compliance with the law 210. If outside legal counsel agrees with the plain English reflection of the law and the proposed program results, outside legal counsel approves the rule documentation report 260 and communicates the approval to the in-house legal team. If outside legal counsel does not agree with the plain English reflection or proposed program results 250, outside legal counsel requests appropriate revisions to the rule documentation report 245. Once agreement is reached on revisions to the rule documentation report 245, a revised rule documentation report is submitted to outside legal counsel for review and final approval 260. Upon final approval 260, the in-house legal team prepares rule change requests 265 for directing the in-house legal technologists to create or revise compliance rules in the compliance rules database repository. Examples of rule change requests are shown in FIGS. 8-11 below. The information in the rule change requests 265 is taken from the approved rule documentation report 245, 250. The rule change requests 265 contain rule logic, program results, explanation of the law, and citation that is being updated.

Turning to FIG. 3, FIG. 3 shows a flow diagram of regulatory compliance rules implementation 300 for storage of computer-encoded rules in a compliance rules repository. FIG. 3 depicts the step of implementing the compliance rules that were generated according to FIG. 2. When rule change requests 310 have been generated, they are entered into a change tracking system 320. The rule change requests include rule logic, program results, explanation of the law and citation 325. A senior member of the in-house legal team checks and reviews the rule change requests against the rule documentation report 330 before approving the rule change requests 335. When necessary, the in-house legal counsel works closely with outside legal counsel to ensure that the law is reflected correctly in the rule change requests. When the in-house legal technologist receives the rule change requests, the in-house legal technologist reviews the rule change request in consultation with the in-house legal team 345 to resolve any questions. The legal technologist then revises or creates computer-encoded compliance rules 350 and incorporates the computer-encoded rules into a development/testing regulatory compliance system 355. The new or revised computer-encoded compliance rules are then tested and evaluated 360 in the development/testing regulatory compliance system by the in-house legal technologist and the quality assurance team. Upon completion of testing by the in-house legal technologist, 360, a senior member of the in-house legal team reviews and validates the new or revised computer-encoded compliance rules 340. The revised computer-encoded compliance rule is then transferred to the quality assurance team for further testing 365. Upon satisfactory testing, review, and validation of the change 340 by the quality assurance team 365, the new or revised computer-encoded compliance rules are released to a production rules repository 370 for use in determining regulatory compliance of compliance review files.

Turning to FIG. 4, FIGS. 4A-4C show a compliance subjects checklist for use in generating rules for a compliance rules repository. The compliance subjects checklist is compared to a new or revised law to determine if new or revised compliance rules are required. An example of topics in a compliance subjects checklist that could be used in the mortgage lending industry is shown in FIG. 4 include 1. Governing Law, 2. Interest Rates and Finance Charges, 3. Calculations of Finance Charges, 4. Payment and Term Limitations, 5. Loan Amount Limitations, 6. Late Charges, 7. Prepayment, 8. Escrow and Impound Requirements, and 9. Origination Fees. Included in the compliance subjects checklist is a licensing subject checklist containing the topic 1. Licensing. Note particularly in FIG. 4A under topic 4. Payment and Term Limitations, the subjects 4.1 Balloon Payment Restrictions and 4.2 Negative Amortization Restrictions. These two subjects will be used subsequently in illustrative examples.

Turning to FIG. 5, FIGS. 5A-5C shows section headings from the Arkansas Code Title 23, Chapter 53, enacted as the Arkansas Home Loan Protection Act. Note that section 23-53-104 Prohibited acts and practices regarding high-cost home loans, from the Arkansas Code Title 23, Chapter 53 is shown in expanded detail. More particularly, note section 23-53-104(f)(1) No Balloon Payment and section 23-53-104(g) No Negative Amortization, both shown in FIG. 5B. These sections will be cited in subsequent illustrative examples.

Turning to FIG. 6, FIG. 6 shows section headings from the Arkansas Code Title 4, Chapter 57, entitled Arkansas Interest and Usury Provisions. Note that section 4-57-101 Calculation of interest, from the Arkansas Code, Title 4, Chapter 57 is shown in expanded detail. More particularly, note section 4-57-101(c)(2), which relates to negative amortization. This section will be cited in subsequent illustrative examples.

Turning to FIG. 7, FIGS. 7A-7E shows selected sections from an Arkansas compliance rule documentation report prepared by an in-house legal team. The compliance rule documentation report is organized in a hierarchical fashion. At the highest hierarchical level of the compliance rule documentation report, the top portion of the compliance rule documentation report shown in FIG. 7A describes the applicable jurisdiction (Arkansas), topic (Governing Law), subject (State Laws Governing Consumer Residential Mortgage Lending), and a listing of the applicable state laws (Arkansas Interest and Usury Provisions, Arkansas Mortgage Loan Companies and Loan Brokers Act, and the Arkansas Home Loan Protection Act).

At the middle hierarchical level of the compliance rule documentation report shown in FIG. 7, the three acts listed above are described from the middle of FIG. 7A through FIG. 7B. The act entitled Arkansas Interest and Usury Provisions (Arkansas Code Title 4, Chapter 57) is described in the lower portion of FIG. 7A. The description also includes an expected program result, an explanation of the law, citation, effective date and approval from outside legal counsel. The act entitled Mortgage Loan Companies and Loan Brokers Act (Arkansas Code Title 23, Chapter 39) is described in the upper portion of FIG. 7B. The description also includes an expected program result, an explanation of the law, citation, effective date and approval from outside legal counsel. The act entitled Arkansas Home Loan Protection Act (Arkansas Code Title 23, Chapter 53) is describe in the lower portion of FIG. 7B. The description also includes an expected program result, an explanation of the law, citation, effective date and approval from outside legal counsel.

At the lowest hierarchical level of the compliance rule documentation report shown in FIG. 7, FIG. 7C describes a heading that includes jurisdiction (Arkansas), topic (Payment/Term Limitations) and subject (Balloon Payment Restrictions). The acts that have sections relating to this subject, Balloon Payment Restrictions, are described under this heading. Under this heading having a subject Balloon Payment Restrictions, the part of the Arkansas Home Loan Protection Act that relates to the subject, Balloon Payment Restrictions, is described by listing the expected program result, explanation of the law, citation, effective date, and approval from outside legal counsel. Note that the citation applicable to this description is Arkansas Code section 23-53-104(f)(1), noted in FIG. 5A above. Also under the heading is a listing acts entitled All Other Acts, which indicates that there are no other acts that have sections relating to the subject, Balloon Payment Restrictions.

Also at the lowest hierarchical level of the compliance rule documentation report shown in FIG. 7, FIG. 7D describes a heading that includes jurisdiction (Arkansas), topic (Payment/Term Limitations) and subject (Negative Amortization Restrictions). The acts that have sections relating to this subject, Negative Amortization Restrictions, are shown in FIG. 7D and FIG. 7E. FIG. 7D lists the act entitled Interest and Usury Provisions that contains section relating to the subject, Negative Amortization Restrictions. It is described by listing the expected program result, explanation of the law, citation, effective date, and approval from outside legal counsel. Note that the citation applicable to this description is Arkansas Code section 4-57-101(c)(2) noted in FIG. 6 above. FIG. 7E lists the act entitled Arkansas Home Loan Protection Act that contains section relating to the subject, Negative Amortization Restrictions. It is described by listing the expected program result, explanation of the law, citation, effective date, and approval from outside legal counsel. Note that the citation applicable to this description is Arkansas Code section 23-53-104(g) noted in FIG. 5B above. Also listed under this heading at the lower portion of FIG. 7E having a subject, Negative Amortization Restrictions, is the act entitled Arkansas Mortgage Loan Companies and Loan Brokers Act, which indicates that this act has no applicable law or sections that address the subject, Negative Amortization Restrictions.

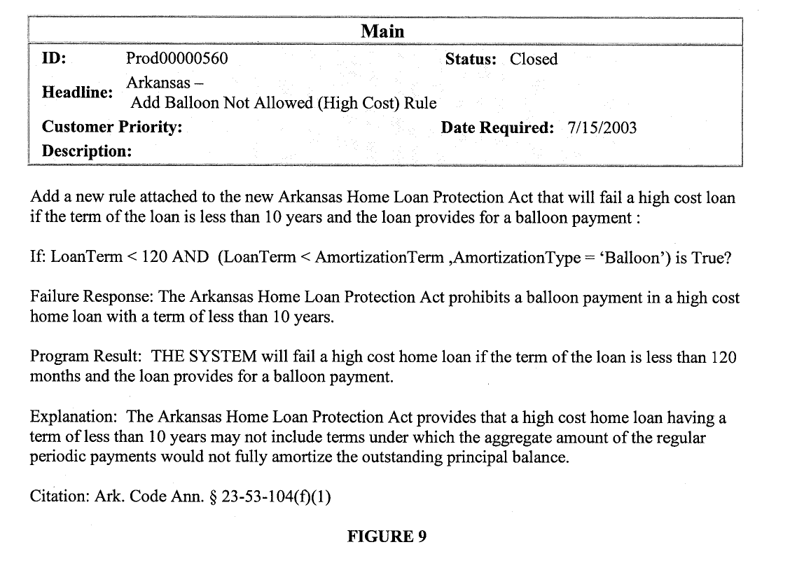

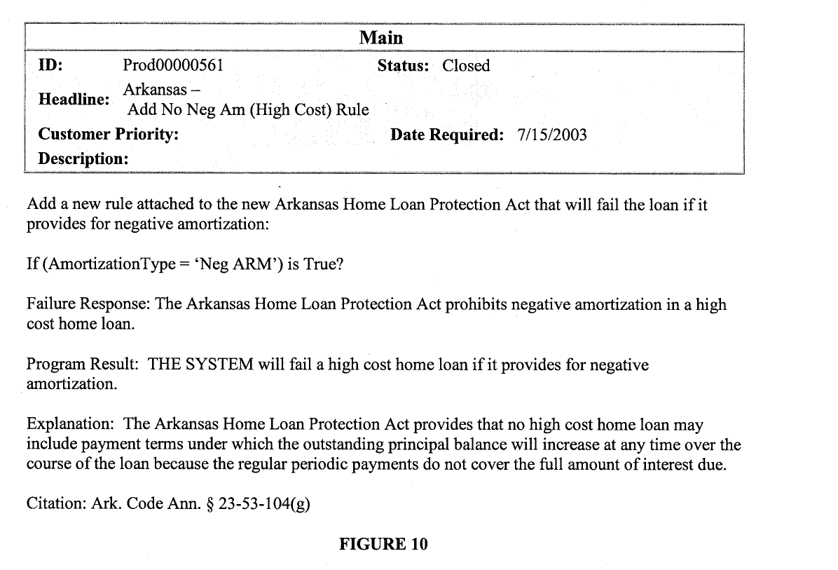

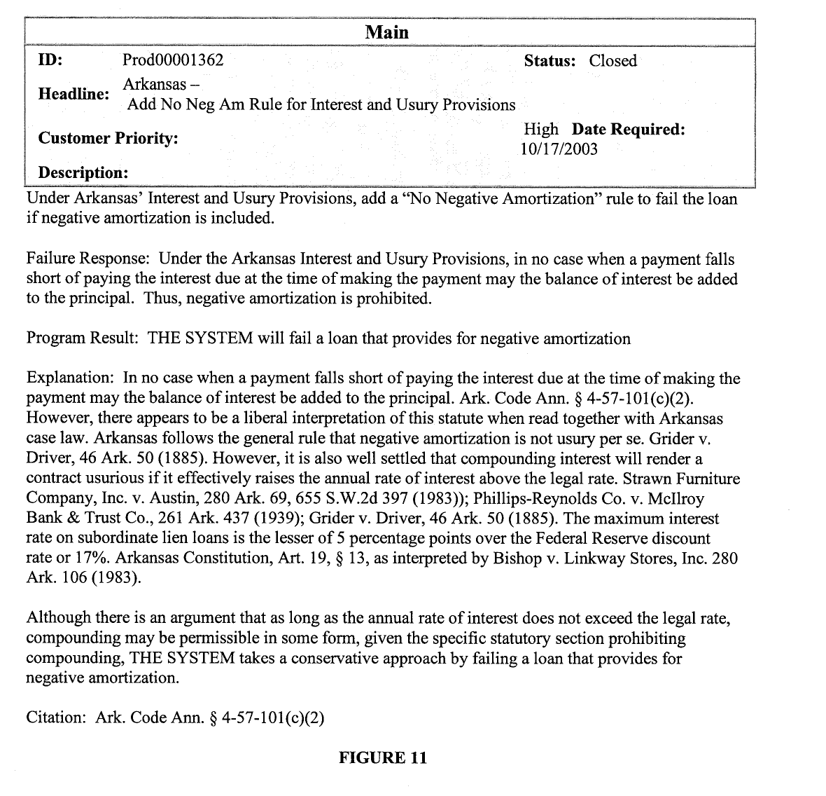

Turning to FIG. 8, FIG. 8 shows a summary of Rule Change Request Documents in a change tracking system. The summary lists a number of rule change request documents by identification number (ID), Headline, Status, Submitter, and Request Type. A detailed change request document identified as Prod00000560 relating to balloon payments in FIG. 8 is shown in FIG. 9. Detailed change request documents identified as Prod0000561 and Prod00001362 relating to negative amortization are shown in FIGS. 10 and 11, respectively.

Turning to FIG. 9, FIG. 9 shows a Rule Change Request in a change tracking system identified as Prod00000560, addressing balloon payments under the Arkansas Home Loan Protection Act, Arkansas Code Title 23, Chapter 53, section 104(f)(1). Arkansas Code section 23-53-104(f)(1) is shown in FIG. 5B and described in the compliance rule documentation report shown in FIG. 7C. The rule change request shown in FIG. 9 includes a header comprising an ID, Status, Headline, Customer Priority, Date Required and Description. The rule change request also includes a plain English description, rule logic, failure response, program result, explanation of the law, and citation. This rule change request provides information with which the in-house legal technologist will use to program and encode the rule logic for storage in a rules repository.

Turning to FIG. 10, FIG. 10 shows a Rule Change Request in a change tracking system identified as Prod00000561, addressing negative amortization under the Arkansas Home Loan Protection Act, Arkansas Code Title 23, Chapter 53, paragraph 104(g). Arkansas Code section 23-53-104(g) is shown in FIG. 5B and described in the compliance rule documentation report shown in FIG. 7E. The rule change request shown in FIG. 10 includes a header comprising an ID, Status, Headline, Customer Priority, Date Required and Description. The rule change request also includes a plain English description, rule logic, failure response, program result, explanation of the law and citation. This rule change request provides information with which the in-house legal technologist will use to program and encode the rule logic for storage in a rules repository.

Turning to FIG. 11, FIG. 11 shows a Rule Change Request in a change tracking system identified as Prod00001362, addressing negative amortization under the Arkansas Interest and Usury Provisions, Arkansas Code Title 4, Chapter 57, paragraph 101(c)(2). Arkansas Code section 4-57-101(c)(2) is shown in FIG. 6 and described in the compliance rule documentation report shown in FIG. 7D. The rule change request shown in FIG. 11 includes a header comprising an ID, Status, Headline, Customer Priority, Date Required and Description. The rule change request also includes a plain English description, rule logic, failure response, program result, explanation of the law and citation. This rule change request provides information with which the in-house legal technologist will use to program and encode the rule logic for storage in a rules repository.

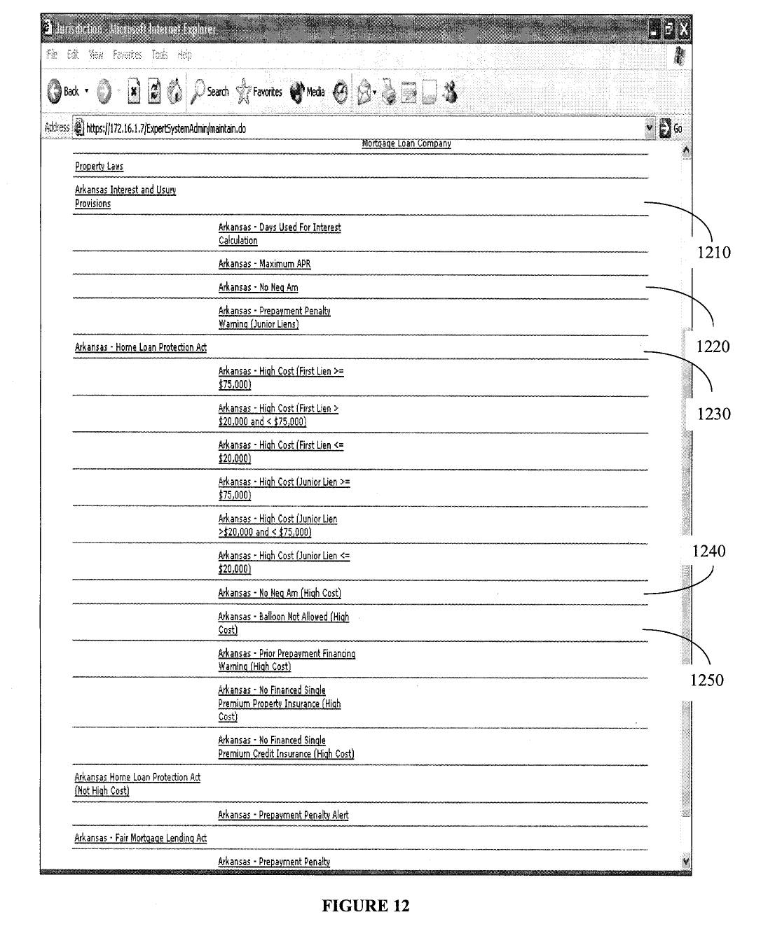

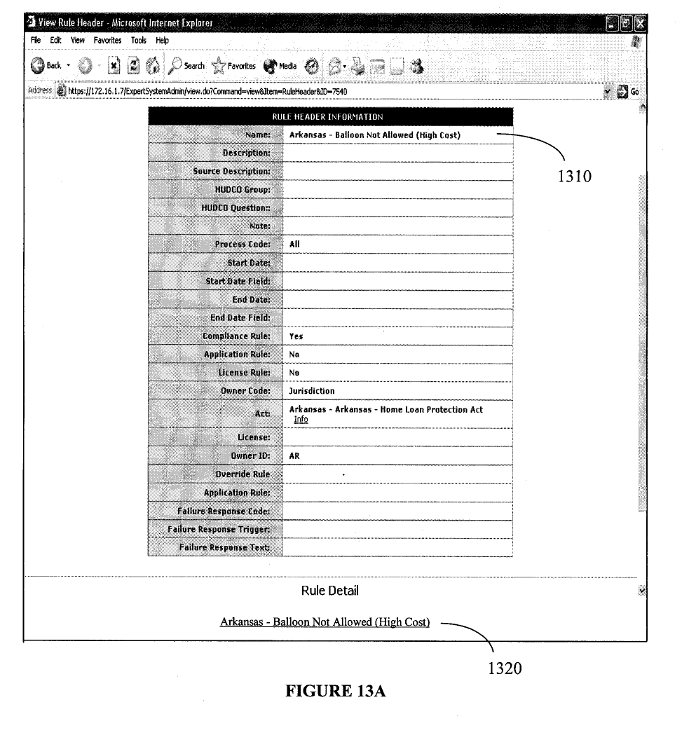

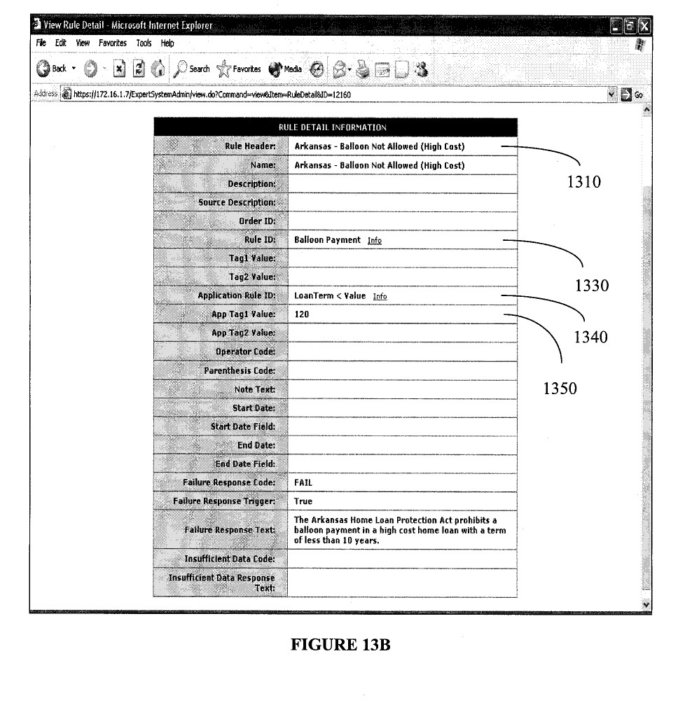

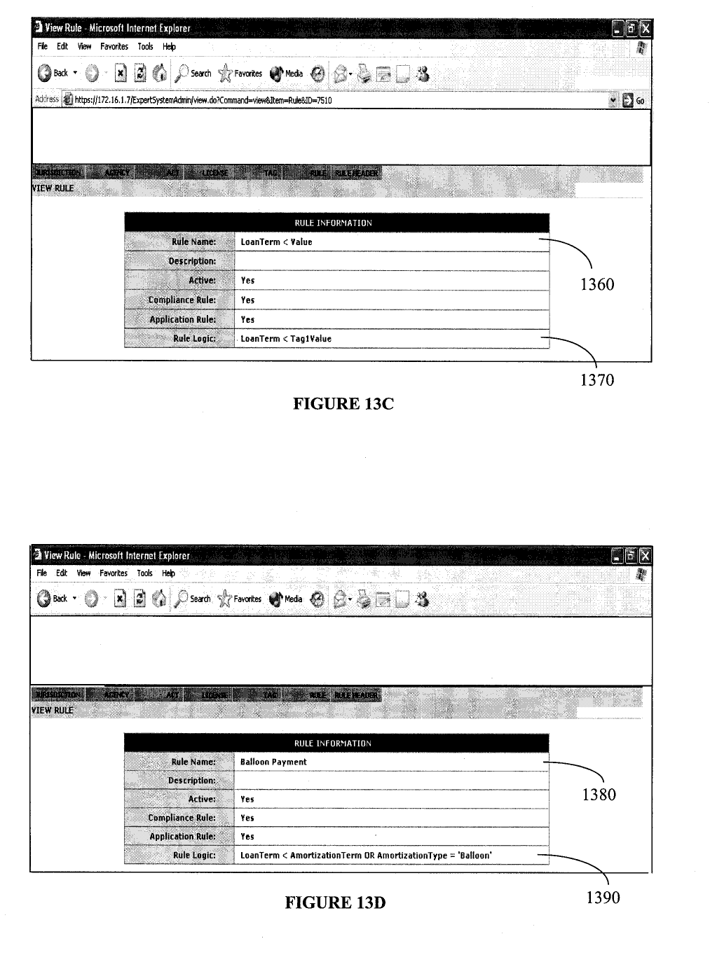

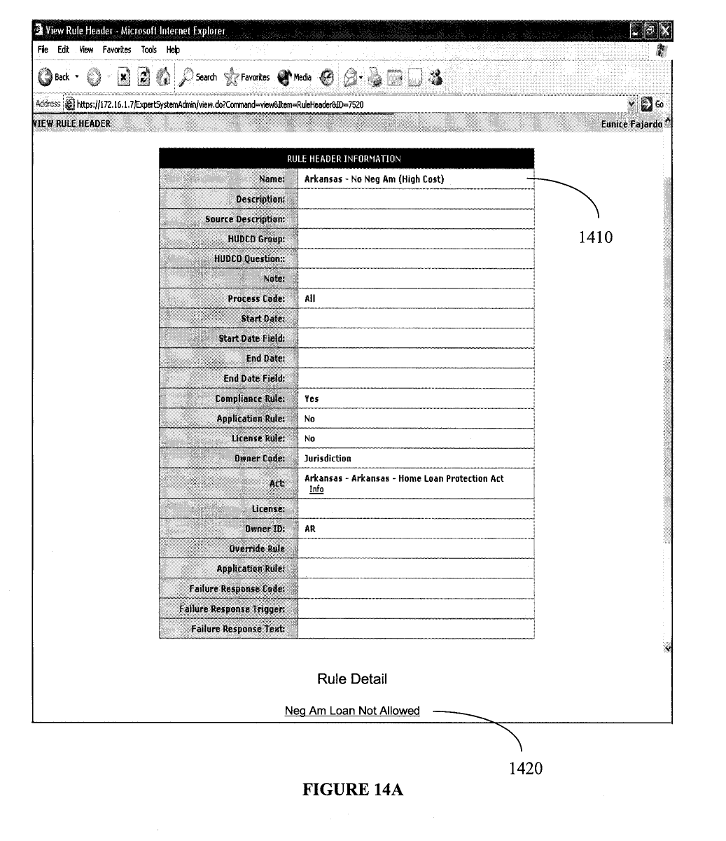

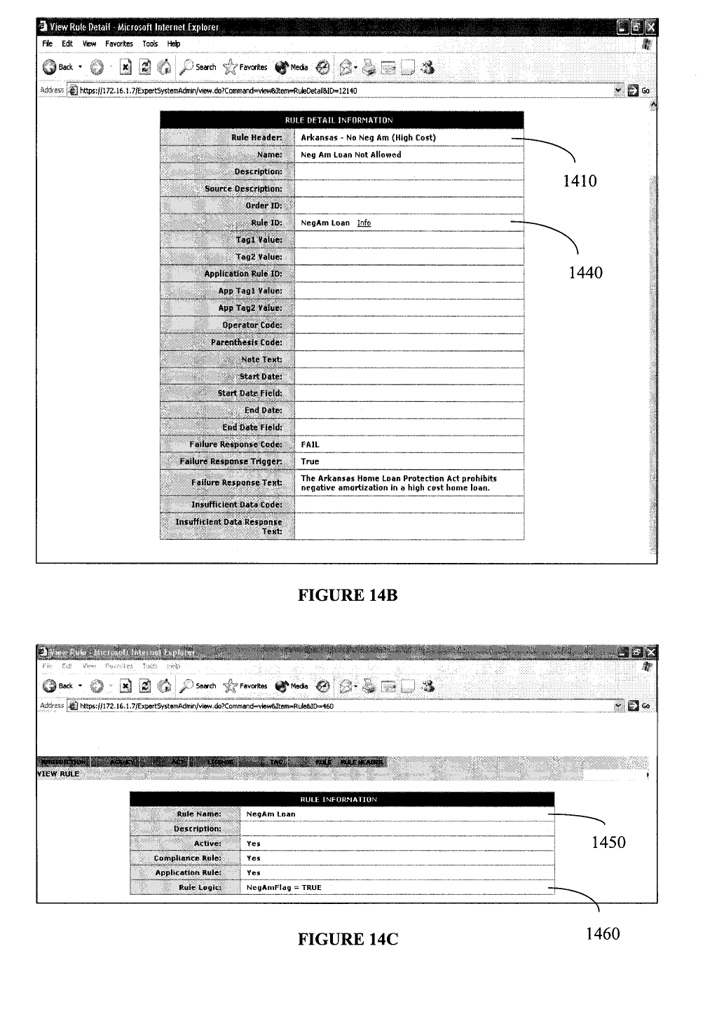

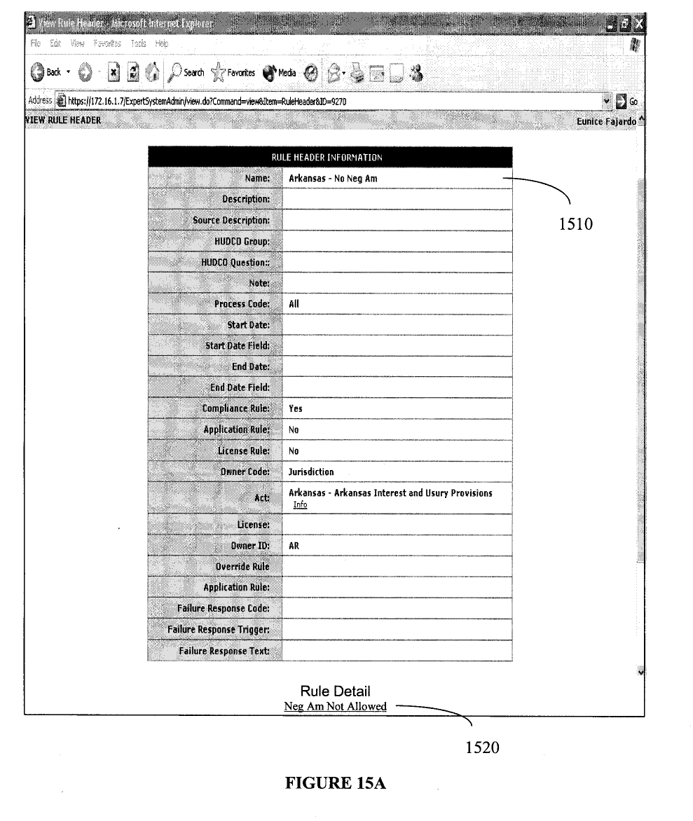

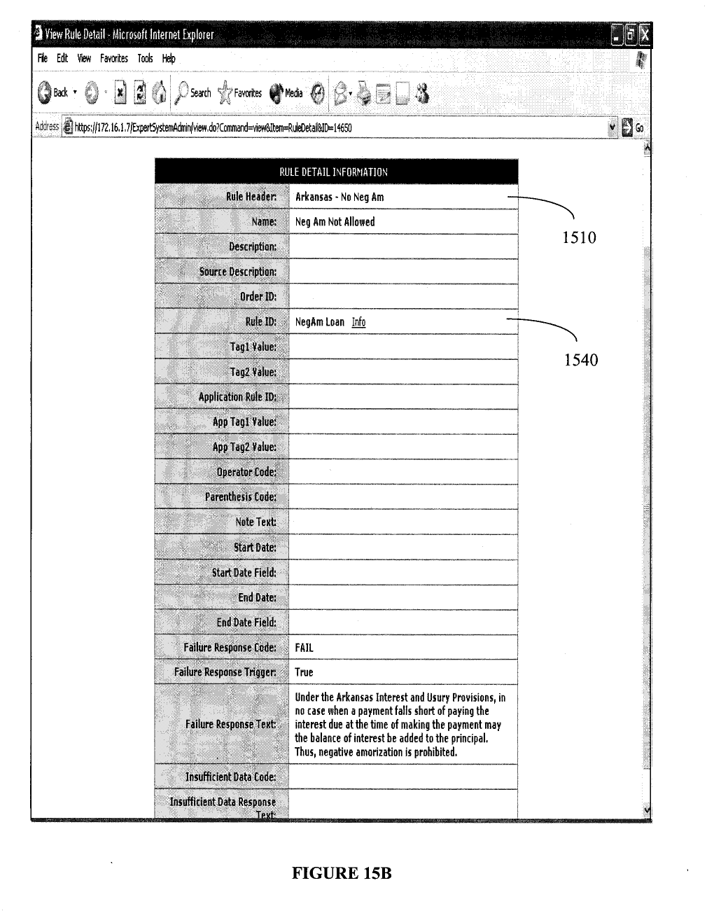

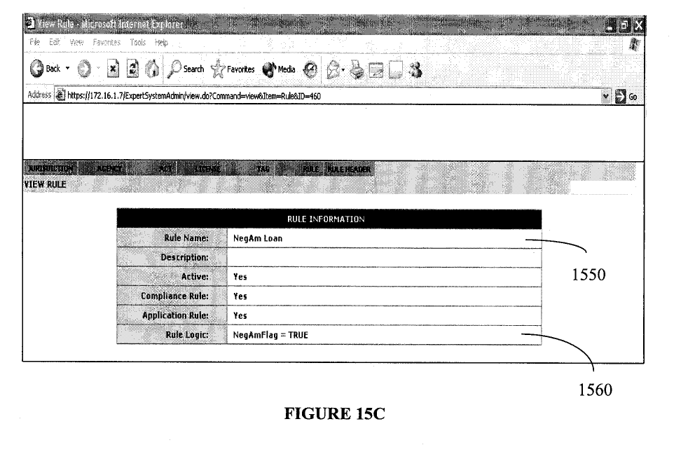

Turning to FIG. 12, FIG. 12 shows a screenshot from a regulatory compliance assessment system depicting rules derived from the Arkansas Interest and Usury Provisions 1210 and the Arkansas Home Loan Protection Act 1230. This screenshot provides a high-level hierarchical overview that enables a user to select more detailed information about a specific rule by clicking appropriate links. By clicking the “Arkansas—No Neg Am” link 1220, the screenshot shown in FIG. 15A is displayed showing more detailed information about this rule. By clicking the “Arkansas—No Neg Am (High Cost)” link 1240, the screenshot shown in FIG. 14A is displayed showing more detailed information about this rule. By clicking the “Arkansas—Balloon Not Allowed (High Cost)” link 1250, the screenshot shown in FIG. 13A is displayed showing more detailed information about this rule.

Turning to FIG. 13, FIG. 13A shows an example of a Rule Header Information screenshot from a regulatory compliance assessment system depicting elements of a rule for flagging noncompliance of a compliance review file providing a balloon payment requirement under the Arkansas Home Loan Protection Act 1310. By clicking the link “Arkansas—Balloon Not Allowed (High Cost)” 1320 in FIG. 13A, the Rule Detail Information screenshot shown in FIG. 13B is displayed showing more detailed information about this rule 1310. By clicking the “Balloon Payment Info” link 1330 in FIG. 13B, the Rule Information screenshot shown in FIG. 13D is displayed showing the Rule Name “Balloon Payment” 1380 and the Rule Logic “Loan Term<AmortizationTerm OR AmortizationType=‘Balloon’” 1390. By clicking the “LoanTerm<Value Info” link 1340 in FIG. 13B, the Rule Information screenshot shown in FIG. 13C is displayed showing the Rule Name “LoanTerm<Value” 1360 and the Rule Logic “LoanTerm<Tag1Value” 1370. The “Tag1Value” in the Rule Logic 1370 shown in FIG. 13B is contained in the App Tag1 Value “120” 1350 shown in FIG. 13B.

Turning to FIG. 14, FIG. 14A shows an example of a Rule Header Information screenshot from a regulatory compliance assessment system depicting elements of a rule for flagging noncompliance of a compliance review file providing a negative amortization requirement under the Arkansas Home Loan Protection Act 1410. By clicking the link “Neg Am Loan Not Allowed” 1420 in FIG. 14A, the Rule Detail Information screenshot shown in FIG. 14B is displayed showing more detailed information about this rule 1410. By clicking the “NegAm Loan Info” link 1440 in FIG. 14B, the Rule Information screenshot shown in FIG. 14C is displayed showing the Rule Name “NegAm Loan” 1450 and the Rule Logic “NegAmFlag=True” 1460.

Turning to FIG. 15, FIG. 15A shows an example of a Rule Header Information screenshot from a regulatory compliance assessment system depicting elements of a rule for flagging noncompliance of a compliance review file providing a negative amortization requirement under the Arkansas Interest and Usury Provisions 1510. By clicking the link “Neg Am Not Allowed” 1520 in FIG. 15A, the Rule Detail Information screenshot shown in FIG. 13B is displayed showing more detailed information about this rule 1510. By clicking the “NegAm Loan Info” link 1540 in FIG. 15B, the Rule Information screenshot shown in FIG. 15 C is displayed showing the Rule Name “NegAm Loan” 1550 and the Rule Logic “NegAmFlag=True” 1560.

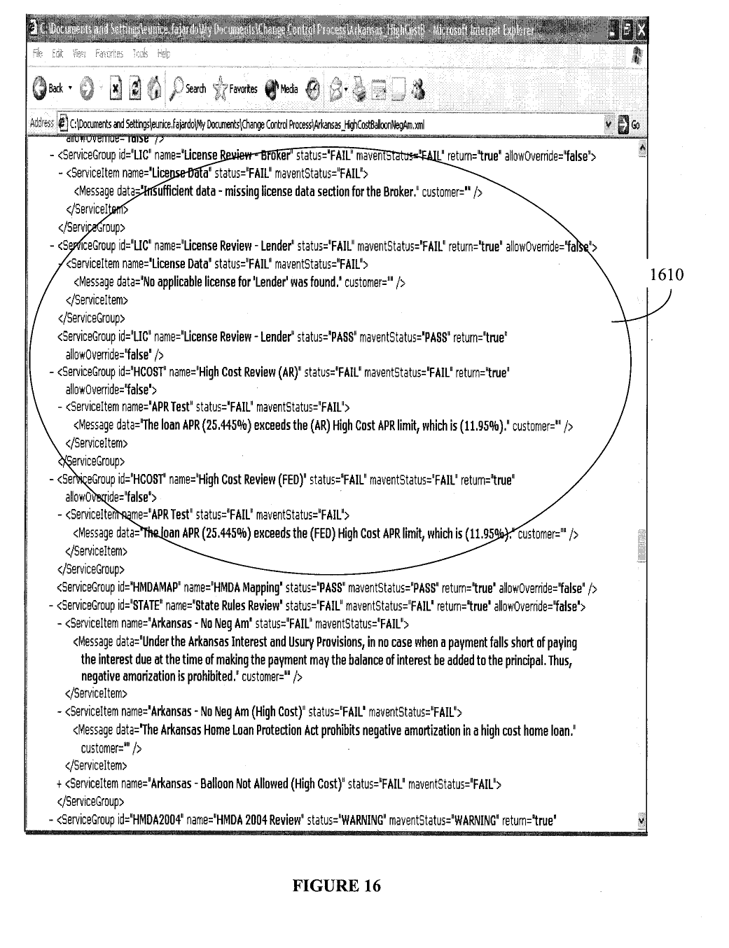

Turning to FIG. 16, FIG. 16 shows an example of a screenshot of a partial compliance review file included within a compliance results file 1610 checked for compliance by the rules stored in a compliance rules repository of a regulatory compliance assessment system. The compliance review file is normally obtained from a financial institution and uploaded to the regulatory compliance assessment system.

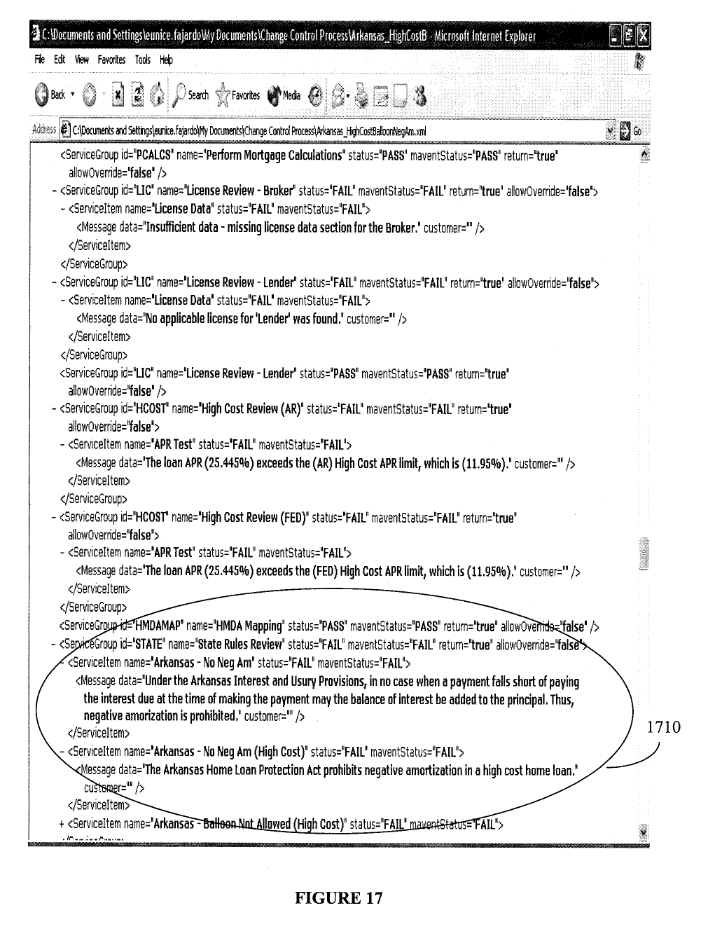

Turning to FIG. 17, FIG. 17 shows an example of a screenshot of a partial regulatory compliance results file 1710 depicting noncompliance with the rules shown in FIGS. 12-15 implemented with rule change requests shown in FIGS. 9-11. The regulatory compliance results file is normally downloaded to the financial institution's compliance review system for alerting the users of areas of noncompliance with regulatory requirements.

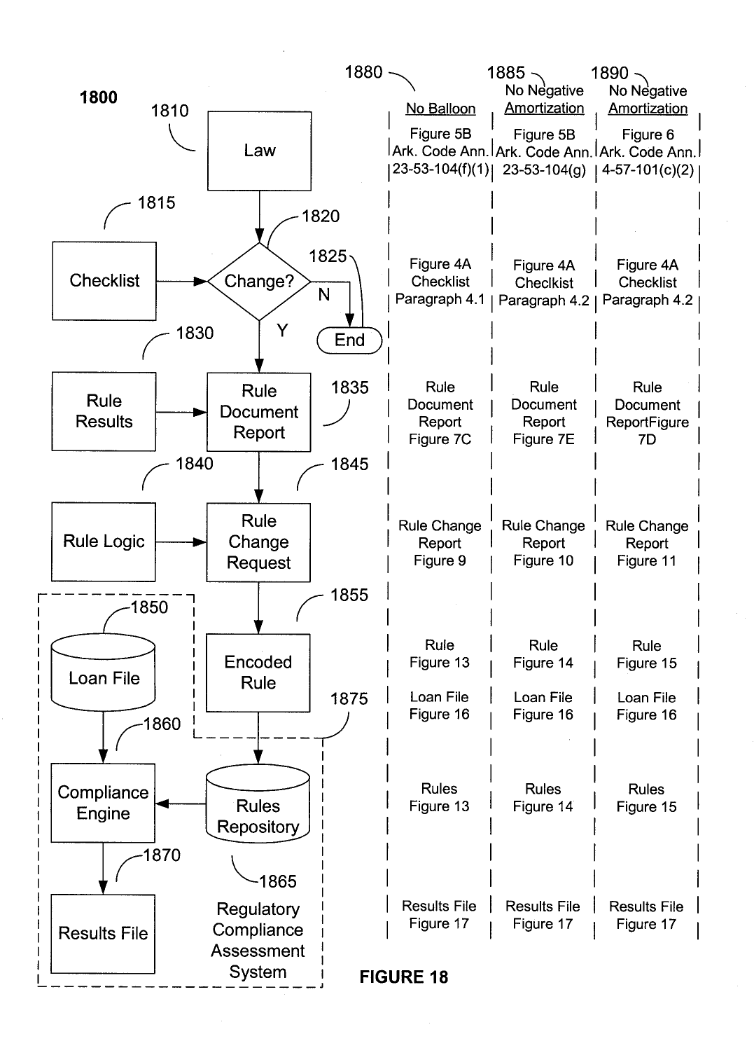

Turning to FIG. 18, FIG. 18 shows the information flow and corresponding example FIGS. 1800 according to the present invention. When a new or revised law 1810 is enacted, it is compared with a compliance subjects checklist 1815 to determine if a change is required 1820 in a rules repository 1865 of a regulatory compliance assessment system 1875. If a change is not required 1820, the process is ended 1825. If a change in the rules repository 1865 is required 1820, a rule documentation report 1835 is prepared defining the expected rule results 1830 in the regulatory compliance assessment system 1875. A rule change request 1845 is prepared defining the rule logic 1840 from the rule documentation report 1835. An computer-encoded rule 1855 is created from the rule change request 1845 and stored in the rules repository 1865 after the rule 1855 has been tested and validated. Within the regulatory compliance assessment system 1875, a compliance engine 1860 assesses a compliance review file 1850 using the computer-encoded rule 1865 stored in the rules repository 1865. The compliance engine 1860 stores the result of the regulatory compliance assessment in a results file 1870, indicating areas of compliance and noncompliance of the compliance review file with regulatory requirements, including the requirements of the existing, new, or revised law 1810. The three columns 1880, 1885, 1890 on the right side of FIG. 18 indicate Figure references of the three examples of non-compliance discussed above, including the requirements for no balloon payments and no negative amortization under the Arkansas Home Loan Protection Act and no negative amortization under the Arkansas Interest and Usury provisions. The Figure references in the columns 1880, 1885, 1890 are shown to the right of the corresponding documents in the information flow diagram on the left side of FIG. 18.

Although the present invention has been described in detail with reference to certain preferred embodiments, it should be apparent that modifications and adaptations to those embodiments might occur to persons skilled in the art without departing from the spirit and scope of the present invention.

1. A method for generation and maintenance of a regulatory compliance rules repository for regulatory compliance assessment, comprising the steps of:
comparing a law imposing requirements for a regulated transaction with a compliance subjects checklist for determining whether a change is required in the regulatory compliance rules repository of a regulatory compliance assessment system, the compliance subjects checklist listing subjects addressed by the regulatory compliance assessment system;
preparing a rule documentation report if a change is required in the regulatory compliance rules repository, the rule documentation report being derived from the law and describing intended results in the regulatory compliance assessment system due to the change and an explanation of the change;
preparing at least one rule change request upon approval of the rule documentation report, the rule change request being derived from the rule documentation report and including rule logic, expected rule results in the regulatory compliance assessment system, relevant law, and legal description;
creating at least one new computer-encoded compliance rule from the at least one rule change request, the new computer-encoded compliance rule being tested, validated, and approved prior to release to the regulatory compliance rules repository; and
assessing regulatory compliance of a compliance review file using a compliance engine to assess the compliance review file using the new computer-encoded compliance rule in the regulatory compliance rules repository to produce a regulatory compliance assessment result file, the regulatory compliance results file indicating subject areas in the compliance review file in compliance and non-compliance with the law.

2. The method of claim 1, wherein the step of comparing a law is selected from the group consisting of comparing an existing law, comparing a new law, and comparing a revised law.

3. The method of claim 1, wherein the step of comparing a law consists of a step selected from the group consisting of comparing a statute, comparing a regulation, comparing a case law, comparing an official interpretation, comparing an attorney general opinion, comparing a determination and other interpretive letter, comparing administration agency regulatory requirements, and comparing a source prescribing and interpreting compliance requirements.

4. The method of claim 1, wherein the step of comparing a law further comprises the step of comparing a law from a jurisdiction selected from the group consisting of a Federal jurisdiction, a state jurisdiction and a local jurisdiction.

5. The method of claim 1, further comprising the step of reviewing the law, generating a legal update and opinion document, and forwarding the legal update and opinion document by an outside legal counsel to an in-house legal team.

6. The method of claim 5, further comprising the step of reviewing the legal update and opinion document by the in-house legal team in consultation with the outside legal counsel.

7. The method of claim 1, wherein the step of comparing further comprises comparing by an in-house legal team.

8. The method of claim 1, wherein the step of preparing a rule documentation report comprises:
preparing a rule documentation report by an in-house legal team with consultation, review and approval by an outside legal counsel of the rule documentation report; and
transmitting the approved rule documentation report back to the in-house legal team.

9. The method of claim 1, wherein the step of preparing at least one change request comprises preparing at least one change request by an in-house legal team.

10. The method of claim 1, further comprising the step of entering the change request into a change tracking system and approving the change request by an in-house legal team.

11. The method of claim 1, further comprising the step of reviewing the change request by an in-house legal technologist in consultation with an in-house legal team.

12. The method of claim 1, wherein the step of creating at least one computer-encoded compliance rule further comprises creating at least one computer-encoded compliance rule by an in-house legal technologist.

13. The method of claim 1, further comprising the step of testing the at least one new computer-encoded compliance rule by a quality assurance team.

14. The method of claim 1, wherein the step of creating at least one computer-encoded compliance rule further comprises the new computer-encoded compliance rule being approved by the in-house legal team prior to release to the regulatory compliance rules repository.

15. A system for generation and maintenance of a regulatory compliance rules repository for regulatory compliance assessment, comprising:
means for comparing a law with a compliance subjects checklist for determining whether a change is required in the regulatory compliance rules repository of a regulatory compliance assessment system, the compliance subjects checklist listing subjects addressed by the regulatory compliance assessment system;
means for preparing a rule documentation report if a change is required in the regulatory compliance rules repository, the rule documentation report being derived from the law and describing intended results in the regulatory compliance assessment system due to the change and an explanation of the change;
means for preparing at least one change request upon approval of the rule documentation report, the rule change request being derived from the rule documentation report and including rule logic, expected rule results in the regulatory compliance assessment system, relevant law, and legal description;
means for creating at least one new computer-encoded compliance rule from the at least one rule change request, the new computer-encoded compliance rule being tested, validated, and approved prior to release to the regulatory compliance rules repository; and
a regulatory compliance assessment system for assessing regulatory compliance of a compliance review file using a compliance engine to process the compliance review file using the new computer-encoded compliance rule in the regulatory compliance rules repository to produce a regulatory compliance assessment result file, the regulatory compliance results file indicating subject areas in the compliance review file in compliance and non-compliance with the law.

16. The system of claim 15, wherein the law is selected from the group consisting of an existing law, a new law and a revised law.

17. The system of claim 15, wherein the law is selected from the group consisting of a statute, regulation, case law, official interpretation, attorney general opinion, determination and other interpretive letter, administration agency regulatory requirements, and a source prescribing and interpreting compliance requirements.

18. The system of claim 15, wherein the law is from a jurisdiction selected from the group consisting of a Federal jurisdiction, a state jurisdiction and a local jurisdiction.

19. The system of claim 15, wherein the compliance subjects checklist contains subjects including governing law, interest rate and finance charge, calculation of finance charges, payment and term limitations, loan amount limitations, late charges, prepayment, escrow and impound requirements, origination fees and licensing.

20. The system of claim 15, wherein the rule documentation report is organized by jurisdiction, topic, subject and act.

21. The system of claim 20, wherein the act is organized by program result, explanation of the law, citation, and effective date.

22. The system of claim 20, wherein the subject is listed in the compliance subjects checklist.

23. The system of claim 15, wherein the change request is organized according to identification, status, headline, customer priority, date required, description, failure response, program result, explanation of the law, and citation.

24. A system for generation and maintenance of a regulatory compliance rules repository for regulatory compliance assessment, comprising:
a law promulgated by a Federal, state or local jurisdiction imposing requirements for financial transactions;
a compliance subjects checklist including subjects addressed by a regulatory compliance assessment system for comparison with the law to identify if a change to the regulatory compliance rules repository is required;
a rule documentation report derived from the law describing intended results of the identified change to the regulatory compliance assessment system;
at least one change request derived from the rule documentation report describing rule logic, expected results in the regulatory compliance assessment system, relevant law and legal description;
at least one new computer-encoded compliance rule for use by the regulatory compliance assessment system computer-encoded from information contained in the at least one rule change request and stored in the regulatory compliance rules repository; and
the regulatory compliance assessment system comprising the regulatory compliance rules repository, at least one compliance review file, a compliance engine for assessing the at least one compliance review file using the new computer-encoded compliance rule stored in the regulatory compliance rules repository, and storing compliance assessment results in a regulatory compliance results file, the regulatory compliance results file indicating subject areas in the compliance review file in compliance and non-compliance with the law.

25. The system of claim 24, wherein the law is selected from the group consisting of a statute, regulation, case law, official interpretation, attorney general opinion, determination and other interpretive letter, administration agency regulatory requirements, and a source prescribing and interpreting compliance requirements.

26. The system of claim 24, wherein the compliance subjects checklist contains subjects including governing law, interest rate and finance charge, calculation of finance charges, payment and term limitations, loan amount limitations, late charges, prepayment, escrow and impound requirements, origination fees and licensing.

27. The system of claim 24, wherein the rule documentation report is organized by jurisdiction, topic, subject and act.

28. The system of claim 27, wherein the act is organized by program result, explanation of the law, citation, and effective date.

29. The system of claim 27, wherein the subject is listed in the compliance subjects checklist.

30. The system of claim 24, wherein the change request is organized according to identification, status, headline, customer priority, date required, description, failure response, program result, explanation of the law, and citation.

31. A method for generation and maintenance of a regulatory compliance rules repository for regulatory compliance assessment, comprising the steps of:
comparing a law imposing requirements for a regulated transaction with a compliance subjects checklist for determining whether a change is required in the regulatory compliance rules repository;
creating at least one new computer-encoded compliance rule if a change is required in the regulatory compliance rules repository; and
assessing regulatory compliance of a compliance review file using new and existing computer-encoded compliance rules in the regulatory compliance rules repository; and
producing a regulatory compliance assessment result file for indicating subject areas in the compliance review file in compliance and non-compliance with the new and existing computer-encoded compliance rules.

32. The method of claim 31, wherein the compliance subjects checklist lists subjects addressed for regulatory compliance assessment.

33. The method of claim 31, further comprising the step of preparing a rule documentation report if a change is required in the regulatory compliance rules repository.

34. The method of claim 33, wherein the rule documentation report is derived from the law and describing intended results from the regulatory compliance assessment due to the required change in the regulatory compliance rules repository and an explanation of the required change.

35. The method of claim 33, further comprising the step of preparing at least one rule change request upon approval of the rule documentation report.

36. The method of claim 35, wherein the rule change request is derived from the rule documentation report and includes rule logic, expected rule results from the regulatory compliance assessment, relevant law, and legal description.

37. The method of claim 35, wherein the step of creating at least one new computer-encoded compliance rule further comprises creating at least one new computer-encoded compliance rule from the at least one rule change request, the new computer-encoded compliance rule being tested, validated, and approved prior to release to the regulatory compliance rules repository.

38. The method of claim 31, wherein the step of comparing a law is selected from the group consisting of comparing an existing law, comparing a new law and comparing a revised law.
